(19) United States
(12) Patent Application Publication
(10) Pub. No.: US 2017/0111247 A1
(43) Pub. Date: Apr. 20, 2017

(54) DEVICE MANAGEMENT APPARATUS, DEVICE MANAGEMENT SYSTEM, DEVICE MANAGEMENT METHOD, AND COMPUTER-READABLE RECORDING MEDIUM

(71) Applicants: DAIGO UCHIYAMA, Tokyo (JP); Kiyohiro Hyo, Tokyo (JP)

(72) Inventors: DAIGO UCHIYAMA, Tokyo (JP); Kiyohiro Hyo, Tokyo (JP)

(73) Assignee: Ricoh Company, Ltd., Tokyo (JP)

(21) Appl. No.: 15/289,383

(22) Filed: Oct. 10, 2016

(30) Foreign Application Priority Data
Oct. 14, 2015 (JP) 2015-203114
Jun. 28, 2016 (JP) 2016-127652

(51) Int. Cl. H04L 12/26; H04L 12/24

(52) U.S. Cl. CPC H04L 43/0805; H04L 41/0853

(57) ABSTRACT

A device management apparatus includes processing circuitry. The processing circuitry is configured to issue management identification information for managing a device; generate mapping information in which the management identification information is associated with device identification information for identifying the individual device; and generate availability management information in which the device identification information is associated with availability indicating whether the device is available or unavailable. The processing circuitry generates the mapping information in which the management identification information associated with the device identification information of a first device is associated with the device identification information of a second device to be identified as the first device when generating, in response to a replacement request to replace the first device with the second device, the availability management information indicating that the first device is unavailable and the availability management information indicating that the second device is available.

### CROSS-REFERENCE TO RELATED APPLICATIONS

The present application claims priority under 35 U.S.C. §119 to Japanese Patent Application No. 2015-203114, filed Oct. 14, 2015 and Japanese Patent Application No. 2016-127652, filed Jun. 28, 2016. The contents of which are incorporated herein by reference in their entirety.

### BACKGROUND OF THE INVENTION

1. Field of the Invention

The present invention relates to a device management apparatus, a device management system, a device management method, and a computer-readable recording medium.

2. Description of the Related Art

In the case of using devices such as image forming apparatuses installed in, for example, an office; it becomes necessary to take measures according to the state of the devices, such as replenishing the consumables, recovering errors, and charging according to the usage volume. For that reason, management needs to be performed in such a way that the state of the devices can be known. However, it is an extremely cumbersome task to perform such device management manually by individuals. In that regard, a device management system has been proposed for the purpose of collective management of devices using a device management apparatus installed in a network.

For example, in Japanese Patent No. 5560756, a device management system is disclosed in which a device management apparatus collects device information (number of printed pages, error information, etc.) indicating the device of each of a plurality of device via the network, and stores the collected information in a corresponding manner to the identification information of the devices. In Japanese Patent No. 5434470, a device management system is disclosed in which a device management apparatus installed in a network stores setting information, which corresponds to the user input, to the identification information of the devices, and sends the setting information in response to the requests from the devices so that the setting information gets reflected in the devices. In Japanese Unexamined Patent Application Publication No. 2005-234622, a device management system is disclosed in which a device management apparatus installed in a network collects the usage volume (count value) from a plurality of devices via the network, stores the usage volume in a corresponding manner to the identification information (device serial numbers) of the devices, calculates the usage fee based on the collected usage value and the contract type, and presents the usage fee to the user.

In such a conventional device management system, a device management apparatus manages a variety of information for each individual device. However, the information to be managed may be preferably managed for each device that is identified as an identical device due to the cognitive recognition of the user, rather than to be managed as information unique to the device. In other words, the device identification by the user is usually based on the cognitive recognition depending on situation of device installation, for example, as the printer installed in the 3F meeting room. Specifically, when a device is replaced with another one due to device failure, the cognitive recognition identifies the device after the replacement to be the device before the replacement. Accordingly, it is very often desired to continually use the settings for the previous device as the settings for the new device, or to count the total of the usage volumes of the previous and new devices.

However, convention device management systems do not use the cognitive recognition described above for management, and do treat the devices to be managed as distinguishable individual devices even when one device is identified as another device. Accordingly, in order to continually use the settings for the previous device as the settings for the new device after replacement of the device, it is necessary to apply the setting for the previous device to the new device by a manual operation. In order to count the total of the usage volumes of the previous and new devices, it is necessary to set operation for each replacement such as addition of the usage volume of the new device to the usage volume of the previous device to count the usage volume. Consequently, such conventional device management systems cannot manage information for each individual device that is identified as an identical device due to the cognitive recognition, thereby making the device management cumbersome and complicated.

### SUMMARY OF THE INVENTION

According to one aspect of the present invention, a device management apparatus includes processing circuitry configured to issue management identification information for managing a device; generate mapping information in which the management identification information is associated with device identification information for identifying the individual device; and generate availability management information in which the device identification information is associated with availability indicating whether the device is available or unavailable. The processing circuitry generates the mapping information in which the management identification information associated with the device identification information of a first device is associated with the device identification information of a second device to be identified as the first device when generating, in response to a replacement request to replace the first device with the second device, the availability management information indicating that the first device is unavailable and the availability management information indicating that the second device is available.

### BRIEF DESCRIPTION OF THE DRAWINGS

FIG. 1 is a system configuration diagram illustrating an overview of a device management system according to a first embodiment;

FIG. 2 is a block diagram illustrating an exemplary hardware configuration of a device management apparatus;

FIG. 3 is a block diagram illustrating an exemplary hardware configuration of a device;

FIG. 4 is a block diagram illustrating an exemplary hardware configuration of a management terminal;

FIG. 5 is a block diagram illustrating an exemplary functional configuration of the device management apparatus;

FIG. 6 is a diagram illustrating an exemplary data structure of user information;

FIG. 7 is a diagram illustrating an exemplary data structure of service management information;

FIG. 8 is a diagram illustrating an exemplary data structure of availability management information;

FIG. 9 is a diagram illustrating an exemplary data structure of mapping information;

FIG. 10 is a diagram illustrating an exemplary data structure of history information;

FIG. 11 is a block diagram illustrating an exemplary functional configuration of the device;

FIG. 12 is a block diagram illustrating an exemplary functional configuration of the management terminal;

FIG. 13 is a diagram illustrating an example of a menu screen;

FIG. 14 is a diagram illustrating an example of a user registration screen;

FIG. 15 is a diagram illustrating an example of a login screen;

FIG. 16 is a diagram illustrating an example of a service purchase screen;

FIG. 17 is a diagram illustrating an example of a device registration screen;

FIG. 18 is a diagram illustrating an example of an installation registration screen;

FIG. 19 is a diagram illustrating an example of an uninstallation registration screen;

FIG. 20 is a diagram illustrating an example of a replacement registration screen;

FIG. 21 is a diagram illustrating an example of a setting modification screen;

FIG. 22 is a diagram illustrating an example of a usage volume count screen;

FIG. 23 is a diagram illustrating an example of a device state list screen;

FIG. 24 is a flowchart for explaining an example of operations performed during a user registration operation;

FIG. 25 is a flowchart for explaining an example of operations performed during an authentication operation;

FIG. 26 is a flowchart for explaining an example of operations performed during a service purchase operation;

FIG. 27 is a sequence diagram for explaining an example of operations starting from a user registration operation to a service purchase operation;

FIG. 28 is a flowchart for explaining an example of operations performed during an installation registration operation;

FIG. 29 is a flowchart for explaining an example of operations performed during a mapping registration operation;

FIG. 30 is a flowchart for explaining an example of operations performed during a mapping ID additional-registration operation;

FIG. 31 is a sequence diagram for explaining an example of operations performed during an installation registration operation including a mapping registration operation and a mapping ID additional-registration operation;

FIG. 32 is a flowchart for explaining an example of operations performed during an uninstallation registration operation;

FIG. 33 is a flowchart for explaining an example of operations performed during a mapping cancellation operation;

FIG. 34 is a sequence diagram for explaining an example of operations performed during an uninstallation registration operation including a mapping cancellation operation;

FIG. 35 is a flowchart for explaining an example of operations performed during a replacement registration operation;

FIG. 36 is a flowchart for explaining an example of operations performed during a mapping modification operation;

FIG. 37 is a sequence diagram for explaining an example of operations performed during a replacement registration operation including a mapping modification operation;

FIG. 38 is a flowchart for explaining an example of operations performed during a setting modification operation;

FIG. 39 is a flowchart for explaining an example of operations performed during a setting synchronization operation in the device;

FIG. 40 is a flowchart for explaining an example of operations performed during a setting synchronization operation in the device management apparatus;

FIG. 41 is a flowchart for explaining an example of operations performed during an old-device-ID search operation;

FIG. 42 is a sequence diagram for explaining an example of operations performed during a history information storing operation;

FIG. 43 is a flowchart for explaining an example of operations performed during a usage volume counting operation;

FIG. 44 is a flowchart for explaining an example of operations performed during a device state list generation operation;

FIG. 45 is a diagram illustrating a data model assumed in a second embodiment;

FIG. 46 is a system configuration diagram illustrating an overview of a device management system according to the second embodiment;

FIG. 47 is a block diagram illustrating an exemplary functional configuration of a device management apparatus according to the second embodiment;

FIG. 48 is a diagram for explaining an overview of a request receiver;

FIG. 49 is a diagram illustrating an exemplary data structure of group information;

FIG. 50 is a diagram illustrating an exemplary data structure of counter information;

FIG. 51 is a diagram illustrating an exemplary data structure of usage restriction information;

FIG. 52 is a diagram illustrating exemplary screens of a management tool;

FIGS. 53 to 55 are diagrams illustrating examples of a setting input screen;

FIG. 56 is a sequence diagram for explaining an example of operations performed in response to a counter information obtaining request;

FIG. 57A is a diagram illustrating an example of data of a counter information obtaining request;

FIG. 57B is a diagram illustrating an example of data of the response to the counter information obtaining request;

FIG. 58 is a sequence for explaining an example of operations performed in response to a usage restriction information obtaining request;

FIG. 59A is a diagram illustrating an example of data of a usage restriction information obtaining request;

FIG. 59B is a diagram illustrating an example of data of the response to the usage restriction information obtaining request;

FIG. 60 is a sequence diagram for explaining an example of operations performed in response to a usage restriction setting request;

FIG. 61A is a diagram illustrating an example of data of a usage restriction setting request; and

FIG. 61B is a diagram illustrating an example of data of the response to the usage restriction setting request.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described in detail below with reference to the drawings.

### First Embodiment

System Configuration

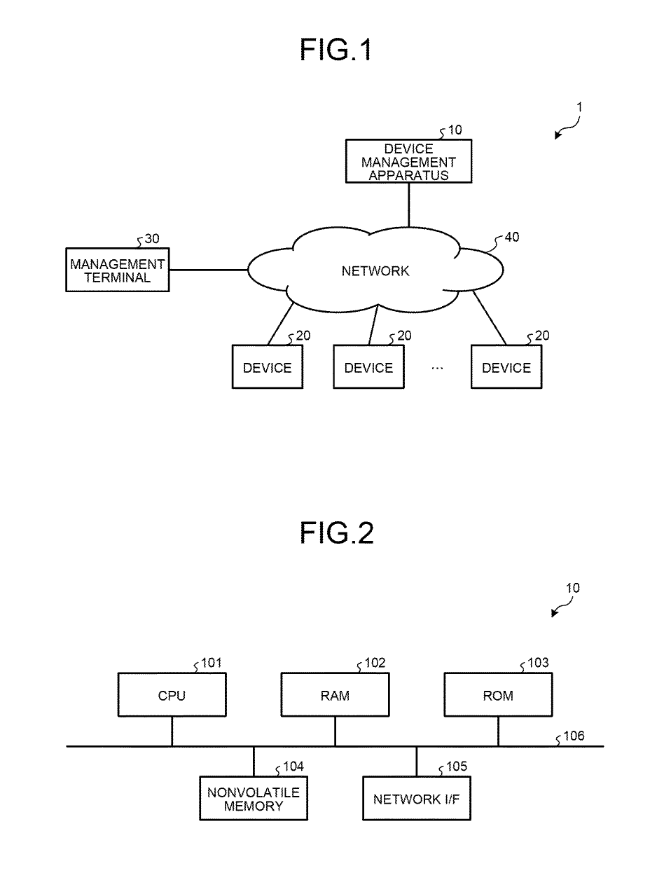

Firstly, the explanation is given about an overview of the device management system according to a first embodiment. FIG. 1 is a system configuration diagram illustrating an overview of a device management system 1 according to the first embodiment. As illustrated in FIG. 1, the device management system 1 includes a device management apparatus 10, a plurality of devices 20 serving as the target devices for management, and a management terminal 30 that is operated by a user for managing the devices 20. The devices 20 and the management terminal 30 are communicably connected to the device management apparatus 10 via a network 40.

The device management apparatus 10 is a server device that provides various services relates to the management of the devices 20. Examples of the services provided by the device management apparatus 10 include management of setting information of the devices 20; collection of log information and management of history information; and collection and management of state information. In the first embodiment, it is assumed that the device management apparatus 10 provides such various services in the form of cloud services. Accordingly, the network 40 is a combination of the Internet, a local area network (LAN), and a wireless LAN. Meanwhile, the device management system 1 can be implemented in a local area too. In that case, a LAN installed in a limited environment is used as the network 40.

Moreover, in the first embodiment, the target devices 20 for management are assumed to be image forming apparatuses such as multifunction peripherals/printers (MFPs). However, there is no particular restriction on the types of the devices 20. Furthermore, there can be an arbitrary number of devices 20 that are to be managed, and various devices 20 that are registered in the device management apparatus 10 and that are connected to the network 40 can be treated as the target devices for management.

Moreover, in the first embodiment, the management terminal 30 is assumed to be an information processing device such as a personal computer (PC), a tablet terminal, or a smartphone. Herein, although the management terminal 30 is used by the user to issue various requests to the device management apparatus 10 without directly operating the devices 20, it is not an essential condition. That is, as long as the device management system 1 according to the first embodiment at least includes the device management apparatus 10 and one or more devices 20 connected to the device management apparatus 10 via the network 40, it serves the purpose.

Exemplary Hardware Configuration of Device Management Apparatus

Given below is the explanation of an exemplary hardware configuration of the device management apparatus 10. As far as the specific hardware of the device management apparatus 10 is concerned, it is possible to use a general-purpose computer. FIG. 2 is a block diagram illustrating an exemplary hardware configuration of the device management apparatus 10. For example, as illustrated in FIG. 2, the device management apparatus 10 includes a central processing unit (CPU) 101, a random access memory (RAM) 102, a read only memory (ROM) 103, a nonvolatile memory 104 such as a hard disk or a flash memory, and a network interface (I/F) 105 that is a communication interface for establishing connection with the network 40. These constituent elements are connected to each other by a bus 106.

In the device management apparatus 10 according to the first embodiment, the CPU 101 makes use of the RAM 102 as the work area, reads predetermined computer programs from the ROM 103 or the nonvolatile memory 104, and executes the computer programs so as to implement various functions (described later). That is, in the device management apparatus 10 according to the first embodiment, various functions (described later) meant for providing various services related to the management of the devices 20 are implemented as a result of cooperation between the hardware and the software (computer programs) of the computer.

Meanwhile, in FIG. 2, although the hardware of only a single computer is illustrated, the device management apparatus 10 according to the first embodiment can be implemented by combining a plurality of computers. That is, the functional constituent elements (described later) of the device management apparatus 10 can be dispersed among a plurality of computers. In that case, for example, the computers constituting the device management apparatus 10 either can be communicably connected via the network 40 or can be directly connected by a cable.

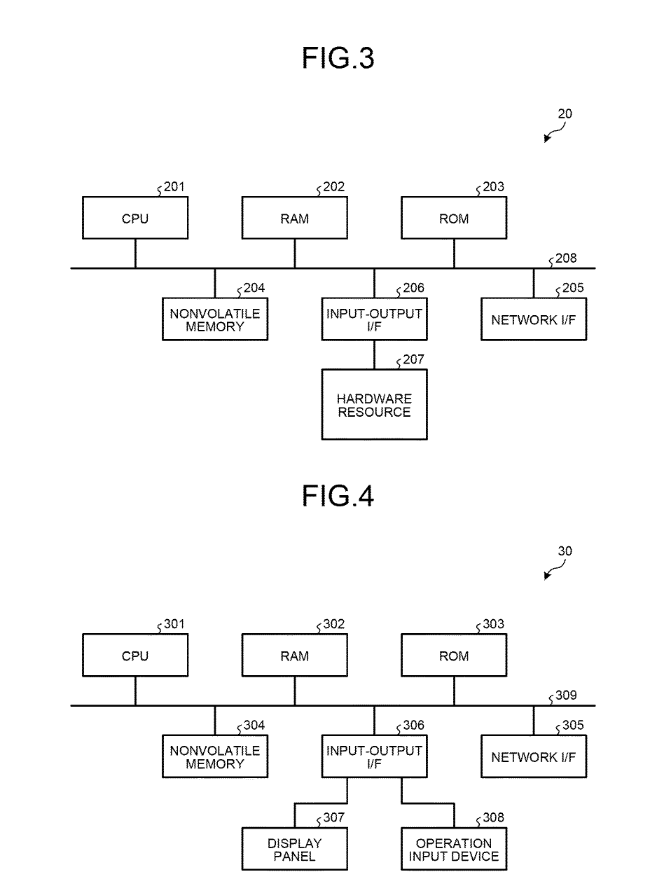

Exemplary hardware configuration of device Given below is the explanation of an exemplary hardware configuration of the device 20. FIG. 3 is a block diagram illustrating an exemplary hardware configuration of the device 20. For example, as illustrated in FIG. 3, the device 20 includes a CPU 201, a RAM 202, a ROM 203, a nonvolatile memory 204 such as a hard disk or a flash memory, a network I/F 205 that is a communication interface for establishing connection with the network 40, an input-output I/F 206, and a hardware resource 207 that is connected to the input-output I/F 206. These constituent elements excluding the hardware resource 207 are connected to each other by a bus 208. Meanwhile, the hardware resource 207 represents a module for implementing the essential functions of the device 20. For example, when the device 20 is an MFP, the hardware resource 207 includes a printer engine, a scanner engine, an engine controller, a fax transceiver, and an operation panel.

In the device 20 according to the first embodiment, the CPU 201 makes use of the RAM 202 as the work area, reads predetermined computer programs from the ROM 203 or the nonvolatile memory 204, and executes the computer programs so as to implement various functions.

Exemplary Hardware Configuration of Management Terminal

Given below is the explanation of an exemplary hardware configuration of the management terminal 30. FIG. 4 is a block diagram illustrating an exemplary hardware configuration of the management terminal 30. For example, as illustrated in FIG. 4, the management terminal 30 includes a CPU 301, a RAM 302, a ROM 303, a nonvolatile memory 304 such as a hard disk or a flash memory, a network I/F 305 that is a communication interface for establishing connection with the network 40, an input-output I/F 306, and a display panel 307 and an operation input device 308 that are connected to the input-output I/F 306. These constituent elements excluding the display panel 307 and the operation input device 308 are connected to each other by a bus 309. The display panel 307 represents a module for enabling the user to view a variety of information. Herein, for example, a liquid crystal display can be used as the display panel 307. The operation input device 308 is used by the user to input requests with respect to the device management apparatus 10. Herein, for example, a mouse, a keyboard, or a touch-sensitive panel can be used as the operation input device 308.

In the management terminal 30 according to the first embodiment, the CPU 301 makes use of the RAM 302 as the work area, reads predetermined computer programs from the ROM 303 or the nonvolatile memory 304, and executes the computer programs so as to implement various functions (described later).

Functional Configuration of Device Management Apparatus

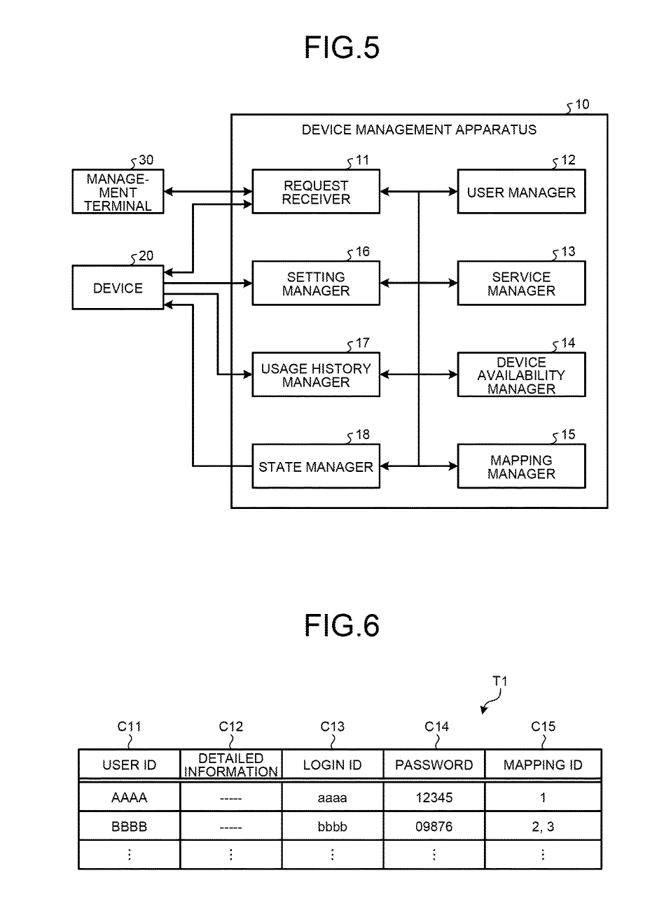

Given below is the explanation of a functional configuration of the device management apparatus 10. FIG. 5 is a block diagram illustrating an exemplary functional configuration of the device management apparatus 10. As the functional constituent elements implemented as a result of cooperation between the hardware and the software described earlier; the device management apparatus 10 includes, for example, a request receiver 11, a user manager 12, a service manager 13, a device availability manager 14, a mapping manager 15, a setting manager 16, a usage history manager 17, and a state manager 18 as illustrated in FIG. 5.

The request receiver 11 represents a functional module that provides with an interface enabling reception of requests issued to the device management apparatus 10. More specifically, at the time when the user operates the device 20 and inputs a request to the device management apparatus 10, the request receiver 11 displays a predetermined interface screen on, for example, an operation panel of the device 20. Moreover, at the time when the user operates the management terminal 30 and inputs a request to the device management apparatus 10, the request receiver 11 displays a predetermined interface screen on the display panel 307 of the management terminal 30. Then, the request receiver 11 receives a request that is input by the user by performing predetermined operations on the interface screen, and sends the received request to other relevant functional modules.

In the first embodiment, examples of a request issued by the user to the device management apparatus 10 include a user registration request, a service purchase request, a device registration request, a setting modification request, a usage volume collection request, and a device state list request.

A user registration request represents a request for registration of the user as a user of the device management system 1. When a user registration request is received as the result of a user operation performed on the interface screen, the request receiver 11 sends the received request to the user manager 12.

A service purchase request represents a request for purchasing a service such as the printing service or the scanning service that is implemented using the device 20. When a service purchase request is received as a result of a user operation performed on the interface screen, the request receiver 11 sends the received request to the service manager 13.

A device registration request represents a request issued by the user in accordance with the installation, uninstallation, or replacement of the device 20. That is, in the case of newly installing the device 20, the user issues an installation request. In the case of uninstalling the device 20 that is already installed, the user issues an uninstallation request. In the case of uninstalling the device 20 that is already installed and newly installing another device 20 (hereinafter, called a new device) as a replacement, the user issues a replacement request. When a device registration request is received as the result of a user operation performed on the interface screen, the request receiver 11 sends the received request to the device availability manager 14.

A setting modification request represents a request for modification in the settings of the device 20. When a setting modification request is received as the result of a user operation performed on the interface screen, the request receiver 11 sends the received request to the setting manager 16.

A usage volume collection request represents a request for collecting the usage volume of the service purchased by the user. When a usage volume collection request is received as the result of a user operation performed on the interface screen, the request receiver 11 sends the received request to the usage history manager 17.

A device state list request represents a request for displaying a list of states of all devices 20 used by the user. Examples of the state of the device 20 include the remaining amount of paper sheets or toner and the presence or absence of errors. When a device state list request is received as the result of a user operation performed on the interface screen, the request receiver 11 sends the received request to the state manager 18.

In the device management system 1 according to the first embodiment, the user can perform predetermined operations on the interface screen provided by the request receiver 11; and can issue various requests described above to the device management apparatus 10. Regarding the details of the operations performed by the user on the interface screen, the explanation is given later along with specific examples of the interface screen provided by the request receiver 11.

Meanwhile, in the first embodiment, although the explanation is given under the premise that the request receiver 11 is included in the device management apparatus 10, the request receiver 11 can alternatively be included in the device 20 or the management terminal 30. In that case, a user request received by the request receiver 11 of the device 20 or the management terminal 30 is sent to the relevant functional modules in the device management apparatus 10 via the network 40.

The user manager 12 represents a functional module for generating and storing user information corresponding to user registration requests, and for performing an authentication operation to authenticate a user using the user information.

FIG. 6 is a diagram illustrating an exemplary data structure of the user information generated by the user manager 12. The user information represents information related to the users of the device management system 1. For example, as illustrated in FIG. 6, the user information is registered and stored in a user management table T1 that is built in the nonvolatile memory 104.

As illustrated in FIG. 6, the user management table T1 includes a “user ID” column C11 used in storing user IDs; a “detailed information” column C12 used in storing detailed information; a “login ID” column C13 used in storing login IDs; a “password” column C14 used in storing passwords; and a “mapping ID” column C15 used in storing mapping IDs.

A user ID represents user identification information enabling identification of a user. When a user registration request is received from the request receiver 11, the user manager issues a user ID and registers it in the “user ID” column C11 in the user management table T1.

The detailed information represents information input by a user at the time of user registration. When the detailed information is input at the time of user registration, the user manager 12 receives the detailed information along with the user registration request from the request receiver 11, and registers the detailed information in the “detailed information” column C12 in the user management table T1.

A login ID and a password represent account information used in authenticating a user, and is input by the user at the time of user registration. As an example of the login ID, it is possible to use the email address of the user. The user manager 12 receives the login ID and the password along with a user registration request from the request receiver 11, and registers the login ID in the “login ID” column C13 and registers the password in the “password” column C14 in the user management table T1. Moreover, when the login ID and the password is received along with a login request from the request receiver 11, the user manager 12 collates the received login ID and the received password with the login IDs and the passwords registered in the user management table T1 and accordingly performs user authentication.

In the device management system 1 according to the first embodiment, the user can log in the device management apparatus 10 also using an account registered with a social networking service (SNS). In that case, the user authentication (external authentication) is done by the user-specified SNS, and the device management apparatus 10 is notified about the authentication result.

A mapping ID represents identification information for management purposes that is used in managing the devices 20. When installation registration of the device 20 is requested, the mapping manager 15 issues a mapping ID. Then, in response to a mapping ID registration request issued by the mapping manager 15, the user manager 12 identifies the user ID with which the mapping ID is to be associated, and additionally registers the mapping ID in the “mapping ID” column C15 in the entry, from among the entries stored in the user management table T1, in which the identified user ID is registered. In the first embodiment, in the user information, a user ID is associated with one or more mapping IDs.

The service manager 13 represents a functional module that generates and stores service management information in accordance with a service purchase request.

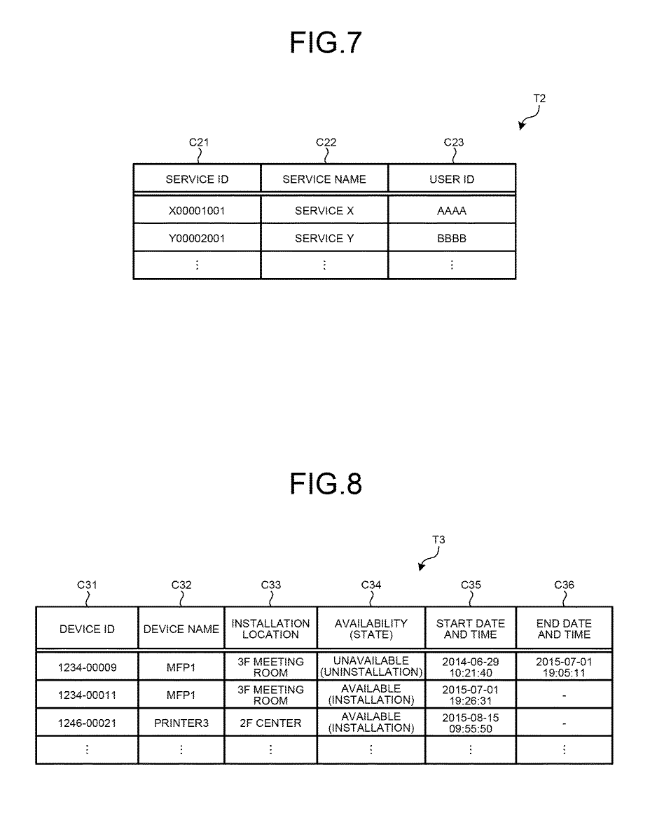

FIG. 7 is a diagram illustrating an exemplary data structure of the service management information generated by the service manager 13. The service management information represents information related to the services purchased by the users. For example, as illustrated in FIG. 7, the service management information is registered and stored in a service management table T2 that is built in the nonvolatile memory 104. Meanwhile, the services purchased by the users are different than the abovementioned services related to the management of the devices 20. Examples of the services purchased by the users include the printing service and the scanning service.

As illustrated in FIG. 7, the service management table T2 includes a “service ID” column C21 used in storing service IDs; a “service name” column C22 used in storing service names; and a “user ID” column C23 used in storing user IDs.

A service ID represents service identification information enabling identification of a service purchased by a user. A service name represents the name given to a purchased service. When a service purchase request having the service to be purchased specified therein is received from the request receiver 11; the service manager 13 issues a service ID, registers the service ID in the “service ID” column C21 in the service management table T2; and registers the service name of the service to be purchased by the user in the “service name” column C22. Moreover, the service manager 13 identifies the user ID of the user who purchased the service and registers the user ID in the “user ID” column C23 in the service management table T2.

The device availability manager 14 represents a functional module that generates, stores, and rewrites availability management information corresponding to device registration requests. Moreover, when a device registration request is an installation registration request; the device availability manager 14 requests the mapping manager 15 to perform mapping registration.

FIG. 8 is a diagram illustrating an exemplary data structure of the availability management information generated by the device availability manager 14. The availability management information represents information related to the registered devices 20 and particularly represents information containing availability of each device 20 indicating whether the device 20 is available or unavailable. Herein, any device 20 is said to be available when that device 20 is installed to be able to implement services such as the printing service and the scanning service. On the other hand, the device 20 is said to be unavailable when that device 20 is installed to be not able to implement services such as the printing service and the scanning service. Meanwhile, for example, as illustrated in FIG. 8, the availability management information is registered and stored in a device availability management table T3 that is built in the nonvolatile memory 104.

As illustrated in FIG. 8, the device availability management table T3 includes a “device ID” column C31 used in storing device IDs; a “device name” column C32 used in storing device names; an “installation location” column C33 used in storing installation locations of the devices 20; an “availability (state)” column C34 used in storing the availability (state); a “start date and time” column C35 used in storing start date and times; and an “end date and time” column C36 used in storing end date and times.

The device IDs represents identification information enabling identification of the individual devices 20. For example, a unique device number (serial number) assigned in advance to each device 20 can be used as the corresponding device ID. In the first embodiment, it is assumed that each target device 20 for management stores its own device ID, and notifies the device management apparatus 10 about the device ID while communicating with the device management apparatus 10. A device name represents the name given to the device 20 and is input by the user along with the installation location of the device 20 at the time of registration of that device 20. The device availability manager 14 receives the device ID, the device name, and the installation location of the device 20 along with a device registration request from the request receiver 11; and registers the device ID, the device name, and the installation location in the “device ID” column C31, the “device name” column C32, and the “installation location” column C33, respectively, in the device availability management table T3.

The availability (state) represents, as described above, information indicating availability or unavailability of the corresponding device 20. That is, the device 20 determined to have available (installation) specified as the availability (state) is in the installation state of being able to implement services such as the printing service and the scanning service. However, the device 20 determined to have unavailable (uninstallation) specified as the availability (state) is uninstalled and is no more in the state of being able to implement services such as the printing service and the scanning service. When a device registration request received from the request receiver 11 is an installation registration request, the device availability manager 14 registers available (installation) in the “availability (state)” column C34 in the device availability management table T3. That is, in response to an installation registration request, the device availability manager 14 generates availability management information in which the availability (state) regarding the target device 20 for installation indicates available (installation). Meanwhile, if the device registration request received by the request receiver 11 is an uninstallation registration request, then the device availability manager 14 rewrites unavailable (uninstallation) in place of available (installation) that is registered in the “availability (state)” column C34 in the entry, from among the entries in the device availability management table T3, in which the device ID of the target device 20 for uninstallation is registered. That is, in response to an uninstallation registration request, the device availability manager 14 generates availability management information in which the availability (state) regarding the target device 20 for installation indicates unavailable (uninstallation).

Meanwhile, if a device registration request received from the request receiver 11 is a replacement registration request, then the device availability manager 14 rewrites unavailable (uninstallation) in place of available (installation) that is registered in the “availability (state)” column C34 in the entry, from among the entries in the device availability management table T3, in which the device ID of the old device (first device) is registered; as well as registers available (installment) in the “availability (state)” column C34 of the entry in which the device ID of the new device (second device) is registered. That is, in response to a replacement registration request, the device availability manager 14 generates availability management information in which the availability (state) regarding the old device indicates unavailable (uninstallation) as well as generates availability management information in which the availability (state) regarding the new device, which is to be identified as the old device 20, indicates available (installation). Since the new device is identified as the old device 20, it is assumed that the device name and the installation location of the old device are used without modification for the new device.

In the first embodiment, in the “availability (state)” column C34 in the device availability management table T3, either available (installation) or unavailable (uninstallation) is registered. Apart from that, for example, some other information such as unavailable (lock) can be registered indicating that the device 20 cannot implement services in spite of being installed. Herein, for example, unavailable (lock) is registered in the “availability (state)” column C34 when the usage volume of a service, such as the printing service or the scanning service, that are implemented using the device 20 reaches the contractual upper limit. When the usage volume of a service is reset, unavailable (lock) is rewritten with available (installation).

The start date and time represents time information indicating the date and time of generation of the availability management information having available (installation) specified as the availability (state). The end date and time represents time information indicating the date and time of rewriting unavailable (uninstallation) as the availability (state). When an installation registration request is received as a device registration request from the request receiver 11, the device availability manager 14 registers, for example, the timing (date and time) of reception of the registration request as the start date and time in the “start date and time” column C35. On the other hand, when an uninstallation registration request is received as a device registration request from the request receiver 11, the device availability manager 14 registers, for example, the timing (date and time) of reception of the registration request as the end date and time in the “end date and time” column C36. Moreover, when a replacement registration request is received as a device registration request from the request receiver 11, the device availability manager 14 registers, for example, the timing (date and time) of reception of the registration request as the end date and time in the “end date and time” column C36 of the entry corresponding to the old device; as well as registers, for example, the timing (date and time) of reception of the registration request as the start date and time in the “start date and time” column C35 of the entry corresponding to the new device.

Meanwhile, the device availability management table T3 illustrated in FIG. 8 is an example in which the start date and time and the end date and time are registered in the unit of year-month-day and hour:minute:second. However, alternatively, the device availability management table T3 can be configured to have the start date and time and the end date and time registered in some other time unit such as the unit of dates.

The mapping manager 15 represents a functional module that generates and stores mapping information in response to a mapping registration request issued by the device availability manager 14. Moreover, when available mapping information is generated, the mapping manager 15 requests the user manager 12 to register a mapping ID.

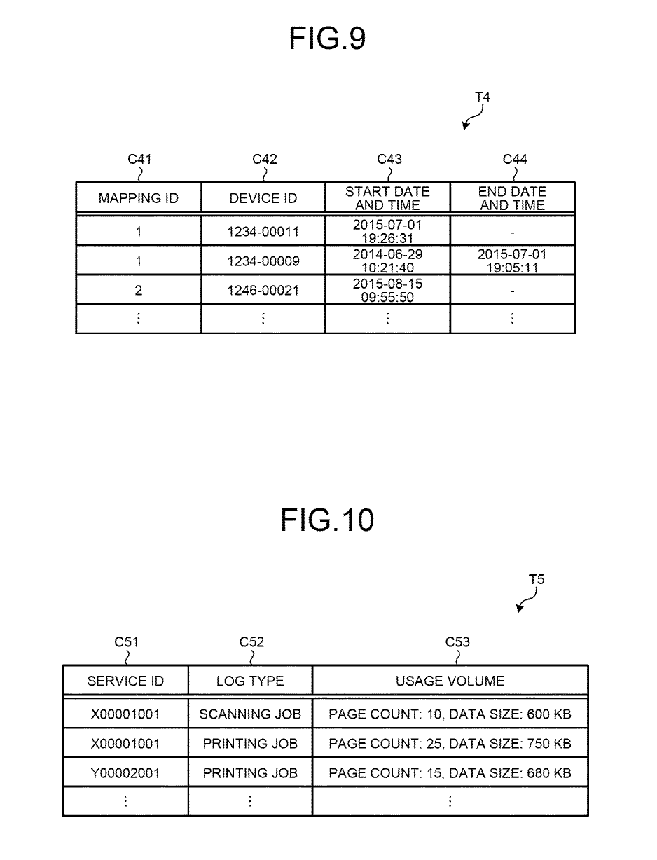

FIG. 9 is a diagram illustrating an exemplary data structure of the mapping information generated by the mapping manager 15. The mapping information represents information for associating mapping IDs with device IDs. For example, as illustrated in FIG. 9, the mapping information is registered and stored in a mapping management table T4 that is built in the nonvolatile memory 104.

As illustrated in FIG. 9, the mapping managing table T4 includes a “mapping ID” column C41 used in storing mapping IDs; a “device ID” column C42 used in storing device IDs; a “start date and time” column C43 used in storing start date and times; and an “end date and time” column C44 used in storing end date and times.

A mapping ID represents identification information for management purposes that is used in managing the devices 20 as described earlier, as well as represents logical identification information that enables identical treatment of the devices 20 that are identified as identical devices due to the cognitive recognition of the user. That is, in response to a replacement registration request, in order to treat a new device that is substituted for an old device as an identical device 20 to the old device, the same mapping ID is used for the old device as well as the new device. When a mapping registration request is received from the device availability manager 14, the mapping manager 15 issues a mapping ID and registers it in the “mapping ID” column C41 in the mapping management table T4; as well as registers the device ID received along with the mapping registration request in the “device ID” column C42 in the mapping management table T4. As a result, the device specified by the device availability manager 14 gets associated with the newly-issued mapping ID.

Moreover, when a mapping modification request is received along with the device ID of an old device and the device ID of a new device, the mapping manager 15 copies, into the “mapping ID” column C41 in the new entry, the mapping ID that is registered in the “mapping ID” column C41 of the entry, from among the entries in the mapping management table T4, which has the device ID of the old device registered therein; as well as registers the device ID of the new device in the “device ID” column C42 in the new entry. As a result, the device ID of the new device gets associated with the mapping ID that was associated with the device ID of the old device.

The start date and time represents time information (first time information) indicating the date and time of association of the device ID with the mapping ID. The end date and time represents time information (second time information) indicating the date and time of cancellation of the association of the device ID with the mapping ID. In the first embodiment, the mapping information for which the start date and time is registered in the “start date and time” column C43 of the mapping management table T4 but for which the end date and time is not registered in the “end date and time” column C44 is treated as available mapping information. On the other hand, the mapping information for which the end date and time is registered in the “end date and time” column C44 is treated as unavailable mapping information. The available mapping information indicates that the association of the device ID with the mapping ID is available, while the unavailable mapping information indicates that the association of the device ID with the mapping ID has been cancelled and is no more available.

When association of the mapping ID and the device ID is established in response to a mapping registration request or a mapping modification request issued by the device availability manager 14, the mapping manager 15 registers, for example, the timing (date and time) of reception of the mapping registration request or the mapping modification request as the start date and time in the “start date and time” column C43 in the concerned entry in the mapping management table T4. That is, in this case, the mapping manager 15 generates available mapping information.

On the other hand, when a mapping cancellation request is received along with a device ID from the device availability manager 14, the mapping manager 15 registers, for example, the timing (date and time) of reception of the mapping cancellation request as the end date and time in the “end date and time” column C44 in the entry, from among the entries in the mapping management table T4, in which the received device ID is registered; and makes the mapping information unavailable. Moreover, when a mapping modification request is received from the device availability manager 14, the mapping manager 15 registers, for example, the timing (date and time) of reception of the mapping modification request as the end date and time in the “end date and time” column C44 in the entry, from among the entries in the mapping management table T4, in which the device ID of the old device received along with the mapping modification request is registered; and makes the mapping information unavailable. That is, in these cases, the mapping manager 15 generates unavailable mapping information.

Meanwhile, the mapping management table T4 illustrated in FIG. 9 is an example in which the start date and time and the end date and time are registered in the unit of year-month-day and hour:minute:second. However, alternatively, the mapping management table T4 can be configured to have the start date and time and the end date and time registered in some other time unit such as the unit of dates.

The setting manager 16 represents a functional module that stores setting information, which is related to the settings of the devices 20, in a corresponding manner to the device IDs. Examples of the settings of the device 20 include the printer settings and the scanner settings of the device 20. Examples of the setting information related to the printer settings include the paper feeding tray settings, the paper type, the paper thickness, and the paper ejection destination. Examples of the setting information related to the scanner settings include the color determination, the next-original standby, the automatic color density setting, and the blank sheet detection. Meanwhile, the setting information related to the settings of the device 20 can also contain other setting items, such as the installed language settings, other than the abovementioned setting items.

Meanwhile, when a setting modification request is received from the request receiver 11; the setting manager 16 modifies, according to the request, the setting information corresponding to the device ID received along with the setting modification request.

Moreover, when a request for setting information is received from the device 20, the setting manager 16 sends the setting information corresponding to the device ID (first device identification information) received along with the request to the device 20 that issued the request. At that time, if the setting manager 16 is not storing the setting information corresponding to the device ID received from the device 20, then the setting manager 16 requests the mapping manager 15 to obtain the device ID (second identification information) whose association with the corresponding mapping ID has been cancelled. The mapping manager 15 can search for the unavailable mapping information containing the mapping ID associated with the specified device ID, and obtain the request device ID. Then, the setting manager 16 associates the setting information corresponding to the obtained device ID, which is obtained by the mapping manager 15, with the device ID received along with the request for setting information; and sends the setting information to the device 20 that issued the request for setting information. Thus, as a result of the replacement of a device 20, when the old device is replaced with a new device, the setting information of the old device can be continually used as the setting information of the new device.

The usage history manager 17 represents a functional module that associates usage-volume-related log information collected from the device 20 with the service ID enabling identification of the service implemented in the concerned device 20, and stores the log information as history information. Moreover, when a usage volume counting request is received from the request receiver 11, the usage history manager 17 retrieves, from the log information stored as history information, the log information corresponding to the service ID received along with the usage volume collection request; and counts the usage volume of the service such as the printing service or the scanning service. Then, the usage history manager 17 sends the usage volume counting result to the request receiver 11. In that case, the request receiver 11 displays the usage volume counting result, which is received from the usage history manager 17, in a viewable manner for the user.

FIG. 10 is a diagram illustrating an exemplary data structure of the history information stored by the usage history manager 17. For example, as illustrated in FIG. 10, the history information is registered and stored in a history management table T5 that is built in the nonvolatile memory 104.

As illustrated in FIG. 10, the history management table T5 includes a “service ID” column C51 used in storing service IDs; a “log type” column C52 used in storing log types; and a “usage volume” column C53 used in storing usage volumes.

In the first embodiment, every time a job such as a printing job or a scanning job is executed in the device 20, it is assumed that the log information related to the executed job is sent along with the device ID from the device 20 to the usage history manager 17 of the device management apparatus 10. The log information contains the log type indicating the type of the job to which the log information is related, and contains the usage volume indicating the number of printed sheets or the number of scanned pages and the data size of the printed data or the scanned data.

When the log information and the device ID is received from the device 20, the usage history manager 17 obtains the service ID corresponding to the received device ID. Then, the usage history manager 17 registers the obtained service ID in the “service ID” column C51 in the history management table T5; registers the log type, which is specified in the log information, in the “log type” column C52; and registers the usage volume, which is specified in the log information, in the “usage volume” column C53.

Given below is the explanation of a sequence of operations performed for obtaining a service ID based on a device ID. Since the service manager 13 stores service IDs as service management information, the usage history manager 17 requests the service manager 13 to obtain the service ID corresponding to the concerned device ID. Since the service managing information stored by the service manager 13 stores service IDs and user IDs stored in a corresponding manner, the service manager 13 requests the user manager 12 to obtain the user ID corresponding to the concerned device ID. Since the user information stored by the user manager 12 contains user IDs and mapping IDs in a corresponding manner, the user manager 12 requests the mapping manager 15 to obtain the mapping ID corresponding to the concerned device ID.

In response to the request received from the user manager 12, the mapping manager 15 obtains the mapping ID corresponding to the concerned device ID based on the mapping information stored therein, and sends the obtained mapping ID to the user manager 12. Then, the user manager 12 obtains the user ID corresponding to the mapping ID obtained by the mapping manager 15, and sends the obtained user ID to the service manager 13. Subsequently, based on the service management information stored therein, the service manager 13 obtains the service ID corresponding to the user ID obtained by the user manager 12; and sends the obtained service ID to the usage history manager 17. As a result of this sequence of operations, the usage history manager 17 receives the log information along with the service ID that corresponds to the device ID received from the device 20. Then, the usage history manager 17 can associate the log information, which is received from the device 20, with the service ID obtained in the manner described above, and store the log information as history information.

The state manager 18 represents a functional module for collecting, from the devices 20, the state information indicating the state of the devices 20; and storing the sets of state information in a corresponding manner to the device IDs. As described earlier, examples of the state of a device include the remaining amount of paper sheets or toner and the presence or absence of errors. Moreover, when a device state list request is received from the request receiver 11, the state manager 18 obtains the device ID of all devices 20 used by the user who input the request, retrieves the sets of state information corresponding to the obtained device IDs, and sends all sets of state information to the request receiver 11. In that case, the request receiver 11 summarizes the sets of state information received from the state manager 18 to generate a device state list screen, and displays it in a viewable manner for the user.

Meanwhile, in the first embodiment, the explanation is given for a configuration in which the sets of state information indicating the state of the devices 20 is stored by the state manager 18 as different information than the history information stored by the usage history manager 17. However, alternatively, the configuration can be such that the state information collected from the devices 20 can be stored as part of the history information that is stored by the usage history manager 17.

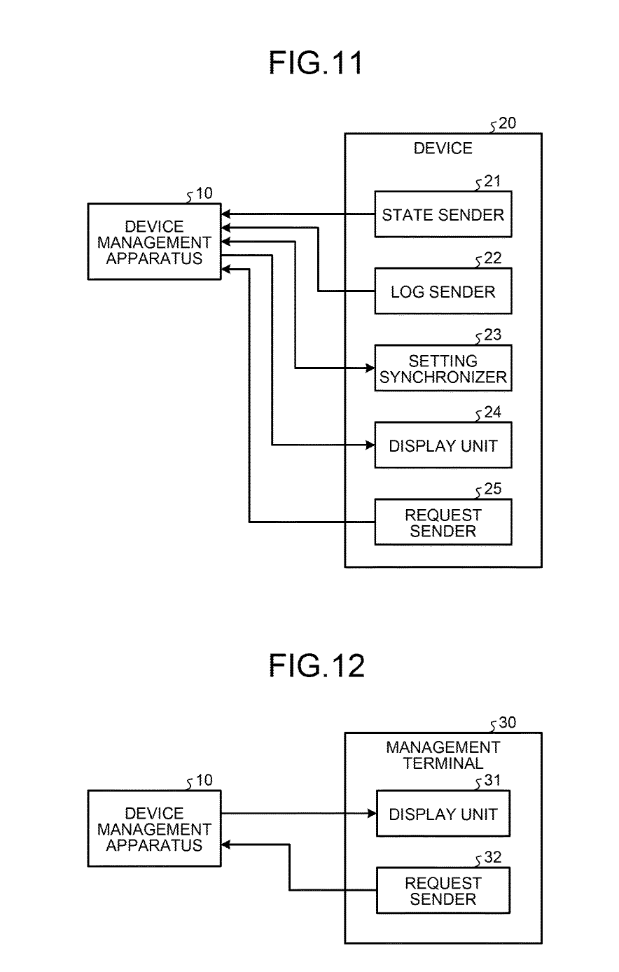

Functional configuration of device Given below is the explanation of a functional configuration of the device 20. FIG. 11 is a block diagram illustrating an exemplary functional configuration of the device 20. As the functional constituent elements implemented as a result of cooperation between the hardware and the software (computer programs) described earlier; the device includes, for example, a state sender 21, a log sender 22, a setting synchronizer 23, a display unit 24, and a request sender 25 as illustrated in FIG. 11.

The state sender 21 represents a functional module that sends the state of the device 20, such as the remaining amount of paper sheets or toner and the presence or absence of errors, to the device management apparatus 10. For example, the state sender 21 checks the remaining amount of paper sheets or toner on a periodic basis or at predetermined timings. When it is detected that the remaining amount of paper sheets or toner is equal to or smaller than a threshold value, the state sender 21 notifies the device management apparatus 10 about that state. At that time, if a plurality of threshold values is set, the remaining amount of paper sheets or toner can be notified at a plurality of levels. Moreover, when an error occurs in the device 20, the state sender 21 notifies the device management apparatus 10 about the occurrence of the error along with the error details. When the error is resolved, the state sender 21 notifies the device management apparatus 10 about the resolution of the error.

The log sender 22 represents a functional module that sends, to the device management apparatus 10, log information related to a job such as a printing job or a scanning job executed in the device 20. Every time a job such as a printing job or a scanning job is executed in the device 20, the log sender 22 generates log information containing the log type and the usage volume, and sends the generated log information to the device management apparatus 10.

The setting synchronizer 23 requests the device management apparatus 10 for the setting information on a periodic basis or at predetermined timings, and obtains the setting information stored by the setting manager 16 of the device management apparatus 10. Then, the setting synchronizer 23 compares the setting information obtained from the device management apparatus 10 with the setting information stored by the device 20. If the two sets of setting information are different, then the setting synchronizer 23 reflects the difference in the settings of the device 20, and updates the setting information stored by the device 20.

The display unit 24 is a functional module that displays interface screens provided by the request receiver 11 of the device management apparatus 10. The request sender 25 represents a functional module that sends, to the device management apparatus 10, a request input by the user by performing predetermined operations on the interface screen that is displayed by the display unit 24.

Functional configuration of management terminal Given below is the explanation of a functional configuration of the management terminal 30. FIG. 12 is a block diagram illustrating an exemplary functional configuration of the management terminal 30. As the functional constituent elements implemented as a result of cooperation between the hardware and the software described earlier; the management terminal 30 includes, for example, a display unit 31 and a request sender 32 as illustrated in FIG. 12.

The display unit 31 represents a functional module that displays an interface screen provided by the request receiver 11 of the device management apparatus 10. The request sender 32 represents a functional module that sends, to the device management apparatus 10, a request input by the user by performing predetermined operations on the interface screen that is displayed by the display unit 31.

Specific examples of interface screen Given below is the explanation of specific examples of the interface screen provided by the request receiver 11 of the device management apparatus 10.

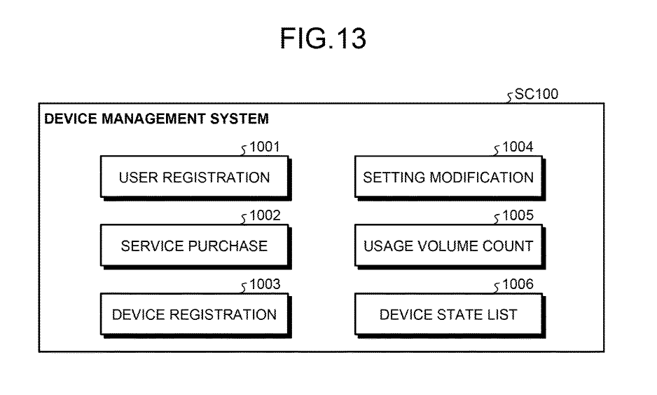

FIG. 13 is a diagram illustrating an example of a menu screen SC100 that represents the initially-displayed interface screen. The menu screen SC100 includes a “user registration” button 1001, a “service purchase” button 1002, a “device registration” button 1003, a “setting modification” button 1004, a “usage volume count” button 1005, and a “device state list” button 1006. The user can selectively operate these buttons and issue various requests to the device management apparatus 10.

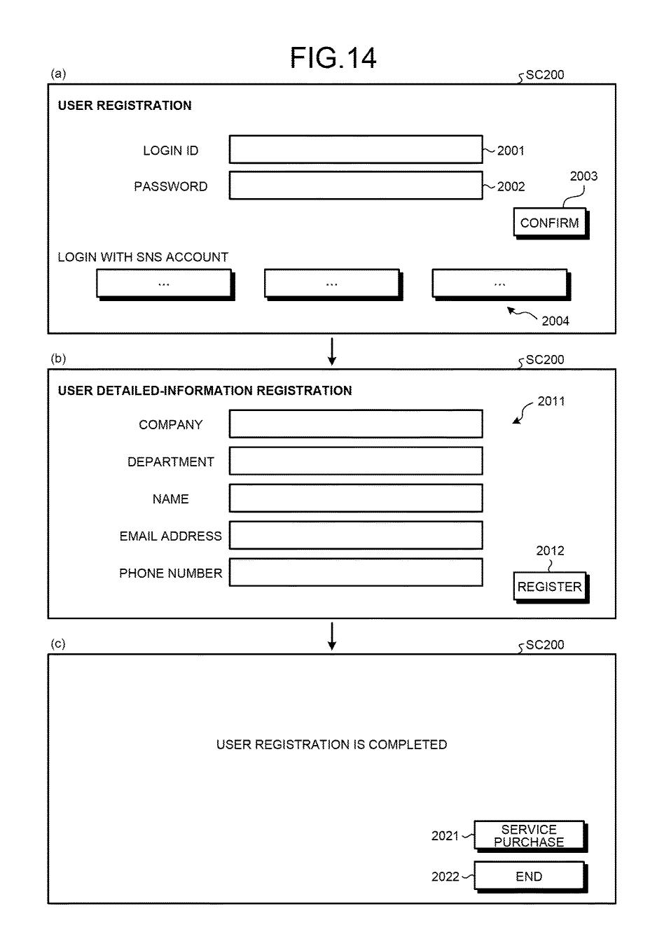

FIG. 14 is a diagram illustrating an example of a user registration screen SC200 that is displayed when the user presses the “user registration” button 1001 provided on the menu screen SC100 illustrated in FIG. 13. As the user registration screen SC200, firstly, a screen illustrated in FIG. 14(a) is displayed. In the screen illustrated in FIG. 14(a), the user inputs the login ID in a textbox 2001, inputs the password in a textbox 2002, and presses a “confirm” button 2003. As a result, the user registration screen SC200 undergoes a transition from the screen illustrated in FIG. 14(a) to the screen illustrated in FIG. 14(b). Moreover, also in the case in which the user presses one of external authentication specification buttons 2004 provided in the screen illustrated in FIG. 14(a), the user registration screen SC200 undergoes a transition from the screen illustrated in FIG. 14(a) to the screen illustrated in FIG. 14(b).

Subsequently, in the screen illustrated in FIG. 14(b), when the user inputs detailed information in a textbox 2011 and presses a “register” button 2012, a user registration request is received by the request receiver 11 of the device management apparatus 10. Then, the user registration request is sent along with the login ID, the password, and the detailed information to the user manager 12. However, the input of the detailed information is not mandatory. That is, even in the case in which the user presses the “register” button 2012 without inputting the detailed information in the textbox 2011, a user registration request is received by the request receiver 11 and is then sent along with the login ID and the password to the user manager 12.

In response to the user registration request, the user manager 12 generates user information. That marks the completion of the user registration. Then, the user registration screen SC200 undergoes a transition from the screen illustrated in FIG. 14(b) to a screen illustrated in FIG. 14(c) and a message about the completion of the user registration is notified to the user. In the screen illustrated in FIG. 14(c), when the user presses a “service purchase” button 2021, the interface screen undergoes a transition to a service purchase screen. However, in the screen illustrated in FIG. 14(c), if the user presses an “end” button 2022, then the display of the interface screen is ended.

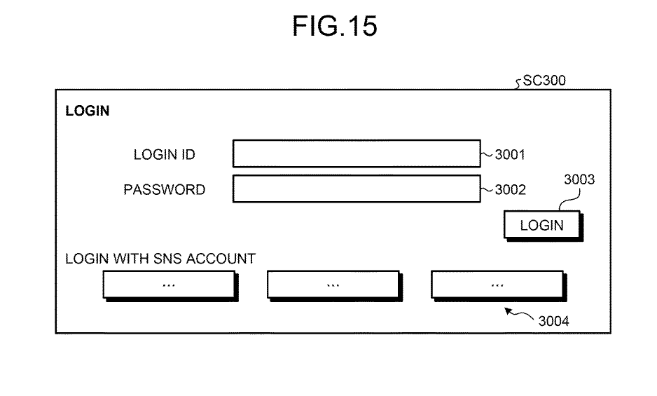

FIG. 15 is a diagram illustrating an example of a login screen SC300. In the case of performing user registration and service purchase in continuation, that is, when the user presses the “service purchase” button 2021 provided in the screen illustrated in FIG. 14(c); the user authentication need not be performed again. However, in the menu screen SC100 illustrated in FIG. 13, if the user presses any one of the “service purchase” button 1002, the “device registration” button 1003, the “setting modification” button 1004, the “usage volume count” button 1005, and the “device state list” button 1006; then the user authentication needs to be performed. Hence, firstly, the login screen SC300 illustrated in FIG. 15 is displayed. In the login screen SC300 illustrated in FIG. 15, when the user inputs the login ID in a textbox 3001, inputs the password in a textbox 3002, and presses a “login” button 3003; a login request is received by the request receiver 11 of the device management apparatus 10. Then, the login request is sent along with the login ID and the password to the user manager 12, so that the user manager 12 performs an authentication operation. Moreover, also in the case in which the user presses one of external authentication specification buttons 3004 provided in the login screen SC300 illustrated in FIG. 15, the external authentication is performed regarding the account registered in the specified SNS. When the result of the user authentication indicates successful authentication, the user is allowed to login.

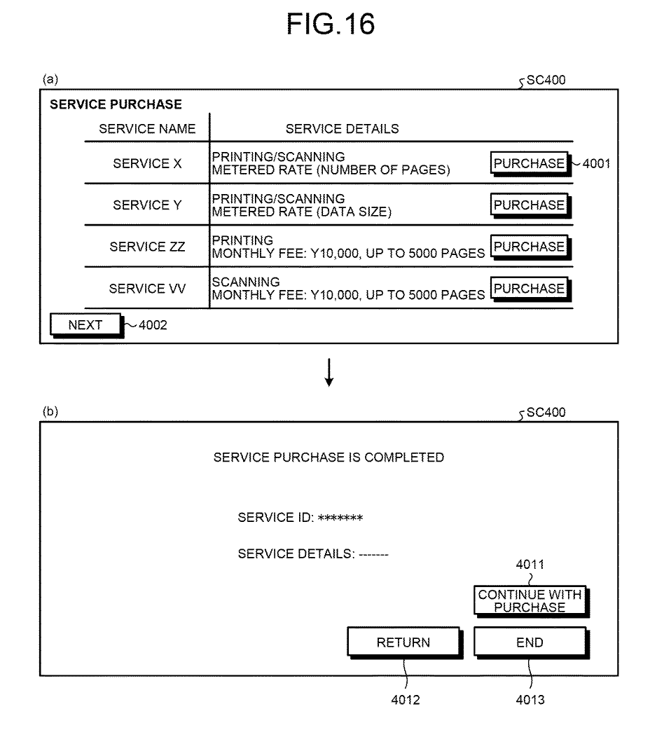

FIG. 16 is a diagram illustrating an example of a service purchase screen SC400 that is displayed when the user either presses the “service purchase” button 2021 provided in the screen illustrated in FIG. 14(c) or presses the “service purchase” button 1002 provided in the menu screen SC100 illustrated in FIG. 13, and is allowed to login. As the service purchase screen SC400, firstly, a screen illustrated in FIG. 16(a) is displayed. In the screen illustrated in FIG. 16(a), a list of services provided using the devices 20, which are managed by the device management apparatus 10, is displayed along with “purchase” buttons 4001. The list of services is updated in response to the pressing of a “next” button 4002. In the screen illustrated in FIG. 16(a), when the user presses the “purchase” button 4001 corresponding to any one service, a service purchase request is received by the request receiver 11 of the device management apparatus 10. Then, the service purchase request is sent along with the user ID to the service manager 13.

When the service manager 13 generates service management information in response to the service purchase request, the service purchase screen SC400 undergoes a transition from the screen illustrated in FIG. 16(a) to a screen illustrated in FIG. 16(b) and a message about the completion of the service purchase is notified to the user. Along with that, the user is notified about the service ID issued by the service manager 13 and about the details of the purchased service. Meanwhile, if the email address is registered as the detailed information of the user, then the same notification is sent to the email address too. Subsequently, in the screen illustrated in FIG. 16(b), when the user presses a “continue with purchase” button 4011, the service purchase screen SC400 returns from the screen illustrated in FIG. 16(b) to the screen illustrated in FIG. 16(a). In the screen illustrated in FIG. 16(a), when the user presses a “return” button 4012, the display returns to the menu screen SC100 illustrated in FIG. 13. Meanwhile, in the screen illustrated in FIG. 16(b), if the user presses an “end” button 4013, then the display of the interface screen is ended.

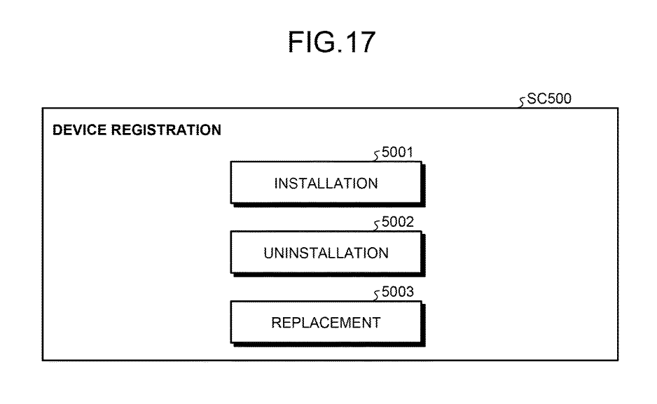

FIG. 17 is a diagram illustrating an example of a device registration screen SC500 that is displayed when the user presses the “device registration” button 1003 provided in the menu screen SC100 illustrated in FIG. 13, and is allowed to login. As described earlier, examples of a device registration request include an installation registration request meant for installing the device 20, an uninstallation registration request meant for uninstalling the device 20, and a replacement registration request meant for replacing an old device with a new device. In order to enable the user to select any one of these requests, the device registration screen SC500 includes an “installation” button 5001, an “uninstallation” button 5002, and a “replacement” button 5003.

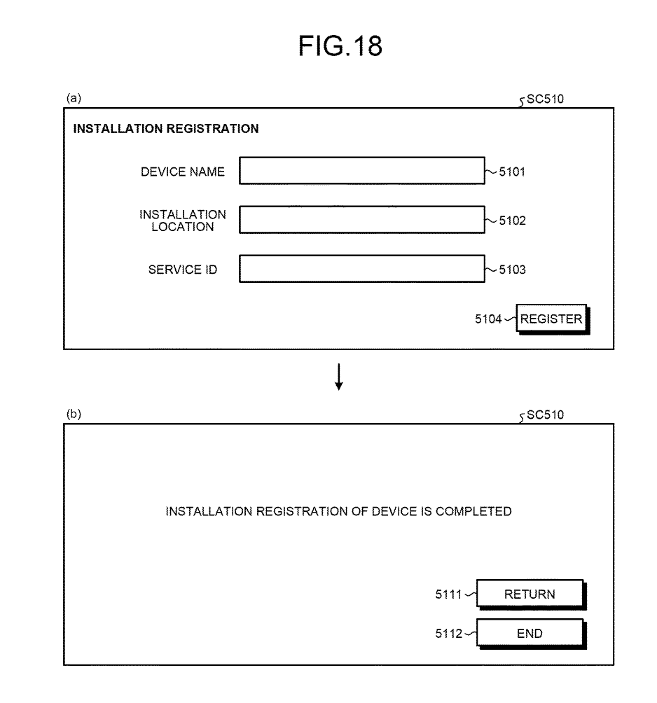

FIG. 18 is a diagram illustrating an example of an installation registration screen SC510 that is displayed when the user presses the “installation” button 5001 provided in the device registration screen SC500 illustrated in FIG. 17. As the installation registration screen SC510, firstly, a screen illustrated in FIG. 18(a) is displayed. In the screen illustrated in FIG. 18(a), when the user inputs, in a textbox 5101, the device name of the device 20 to be installed, inputs the installation location in a textbox 5102, inputs the service ID in a textbox 5103, and presses a “register” button 5104; an installation registration request is received by the request receiver 11 of the device management apparatus 10.

In the first embodiment, it is assumed that a device registration request is issued from the device 20. That is, it is assumed that the user performs operations on the interface screen displayed by the display unit 24 of the device 20 and inputs a device registration request. In that case, since the device ID of the device 20 is sent along with the request to the device management apparatus 10, the user need not input the device ID. However, in the case of issuing a device registration request from the management terminal 30, the user needs to input the device ID of the device 20. Thus, when a registration request for registering the device 20 is received from the management terminal 30, the user is asked to input the device ID in the interface screen. For example, in the case of displaying the installation registration screen SC510 in the management terminal 30, a textbox enabling the input of the device ID is added to the screen illustrated in FIG. 18(a), so that the user can input the device ID.

The installation registration request, which is received by the request receiver 11 of the device management apparatus 10 as a result of operations performed on the screen illustrated in FIG. 18(a), is sent along with the device ID, the device name, and the service ID to the device availability manager 14. Then, the device availability manager 14 generates availability management information in response to the installation registration request, and the mapping manager 15 generates available mapping information. Consequently, the installation registration screen SC510 undergoes a transition from the screen illustrated in FIG. 18(a) to a screen illustrated in FIG. 18(b) and a message about the completion of the installation registration of the device 20 is notified to the user. Subsequently, when the user presses a “return” button 5111 provided in the screen illustrated in FIG. 18(b), the display returns to the menu screen SC100 illustrated in FIG. 13. However, if the user presses an “end” button 5112 in the screen illustrated in FIG. 18(b), then the display of the interface screen is ended.

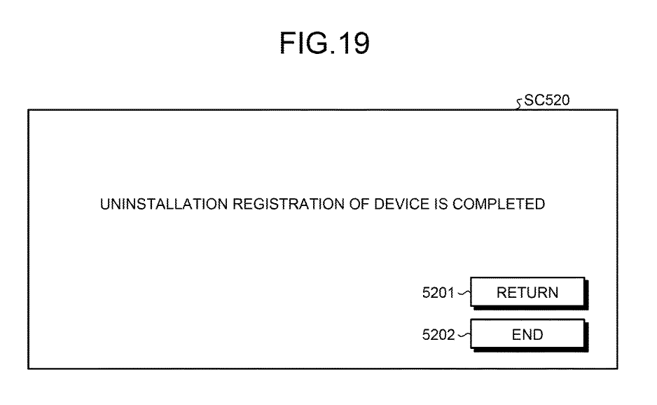

FIG. 19 is a diagram illustrating an example of an uninstallation registration screen SC520 that is displayed when uninstallation registration is completed. When the user presses the “uninstallation” button 5002 provided in the device registration screen SC500 illustrated in FIG. 17, an uninstallation registration request is received by the request receiver 11 of the device management apparatus 10. Then, the uninstallation registration request is sent along with the device ID to the device availability manager 14. Subsequently, in the device availability manager 14, the availability management information corresponding to the target device 20 for uninstallation according to the uninstallation registration request is made unavailable. Moreover, in the mapping manager 15, the mapping information is made unavailable. As a result, the uninstallation registration screen SC520 illustrated in FIG. 19 is displayed and a message about the completion of the uninstallation registration of the device 20 is notified to the user. When the user presses a “return” button 5201 provided in the uninstallation registration screen SC520 illustrated in FIG. 19, the display returns to the menu screen SC100 illustrated in FIG. 13. However, if the user presses an “end” button 5202 in the uninstallation registration screen illustrated in FIG. 19, then the display of the interface screen is ended.

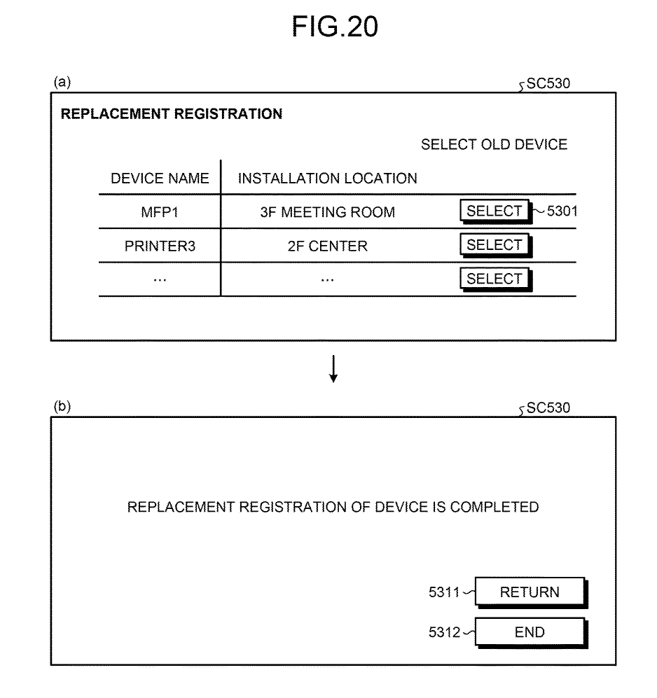

FIG. 20 is a diagram illustrating an example of a replacement registration screen SC530 that is displayed when the user presses the “replacement” button 5003 provided in the device registration screen SC500. As the replacement registration screen SC530, firstly, a screen illustrated in FIG. 20(a) is displayed. In the screen illustrated in FIG. 20(a), a list of devices 20 that are in the installation state and that are in use by the user is displayed, that is, a list of devices 20 that are to be treated as old devices is displayed along with “selection” buttons 5301. In the screen illustrated in FIG. 20(a), when the user presses the “selection” button 5301 corresponding to any one device 20, a replacement registration request is received by the request receiver 11 of the device management apparatus 10. That is, the request receiver 11 of the device management apparatus 10 receives a replacement registration request for replacing the device 20 that is selected by the user in the replacement registration screen SC530 (i.e., replacing an old device) with the device 20 in which the replacement registration screen SC530 is being displayed (i.e., with a new device). Then, the replacement registration request is sent along with the device ID of the old device and the device ID of the new device to the device availability manager 14.

Subsequently, the device availability manager 14 makes the availability management information corresponding to the old device unavailable in response to the replacement registration request, and generates availability management information corresponding to the new device. Moreover, the mapping manager 15 makes the mapping information corresponding to the old device unavailable and generates available mapping information corresponding to the new device. Consequently, the replacement registration screen SC530 undergoes a transition from the screen illustrated in FIG. 20(a) to the screen illustrated in FIG. 20(b) and a message about the completion of the replacement registration of the device 20 is notified to the user. When the user presses a “return” button 5311 provided in the screen illustrated in FIG. 20(b), the display returns to the menu screen SC100 illustrated in FIG. 13. However, if the user presses an “end” button 5312 in the screen illustrated in FIG. 20(b), then the display of the interface screen is ended.

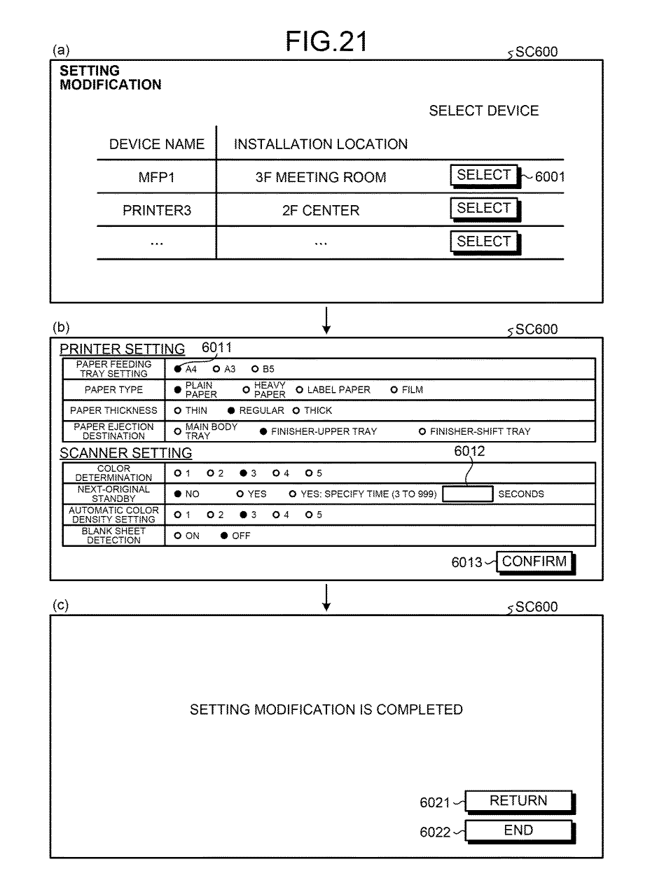

FIG. 21 is a diagram illustrating an example of a setting modification screen SC600 that is displayed when the user presses the “setting modification” button 1004 provided in the menu screen SC100 illustrated in FIG. 13, and is allowed to login. As the setting modification screen SC600, firstly, a screen illustrated in FIG. 21(a) is displayed. In the screen illustrated in FIG. 21(a), a list of devices 20 that are in the installation state and that are in use by the user is displayed along with “selection” buttons 6001. In the screen illustrated in FIG. 21(a), when the user presses the “selection” button 6001 corresponding to any one device 20, the setting modification screen SC600 undergoes a transition from the screen illustrated in FIG. 21(a) to a screen illustrated in FIG. 21(b). In the screen illustrated in FIG. 21(b), the current setting information related to the device 20 selected in the screen illustrated in FIG. 21(a) is displayed along with checkboxes 6011 and a textbox 6012. In the screen illustrated in FIG. 21(b), when the user puts checks in the checkboxes 6011 and inputs a desired value in the textbox 6012 as part of the modification details of the setting information and presses a “confirm” button 6013, a setting modification request is received by the request receiver 11 of the device management apparatus 10. Then, the setting modification request is sent to the setting manager 16 along with the device ID of the device 20 to be subjected to setting modification, that is, the device ID of the device 20 selected in the screen illustrated in FIG. 21(a), and along with the modification details.

Then, the setting manager 16 modifies the setting information in response to the setting modification request. Consequently, the setting modification screen SC600 undergoes a transition from the screen illustrated in FIG. 21(b) to a screen illustrated in FIG. 21(c) and a message about the completion of the setting modification is notified to the user. When the user presses a “return” button 6021 provided in the screen illustrated in FIG. 21(c), the display returns to the menu screen SC100 illustrated in FIG. 13. However, in the screen illustrated in FIG. 21(c), if the user presses an “end” button 6022, then the display of the interface screen is ended.

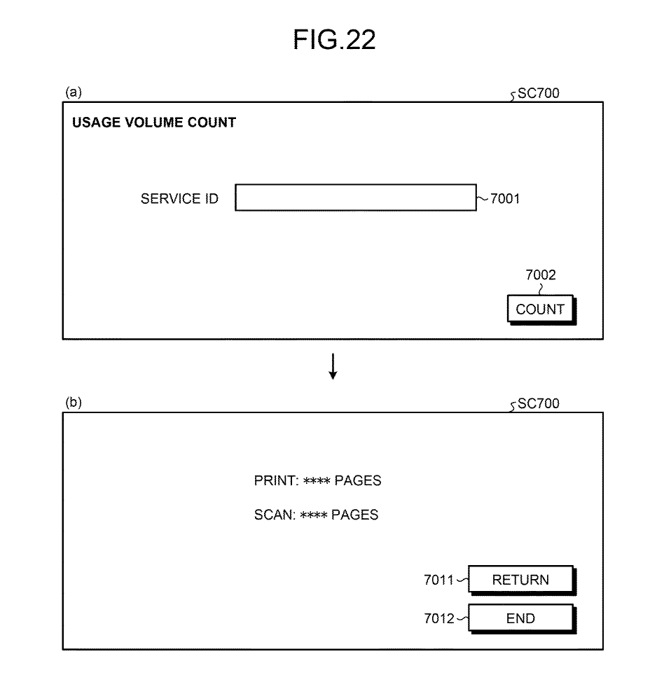

FIG. 22 is a diagram illustrating an example of a usage volume count screen SC700 that is displayed when the user presses the “usage volume count” button 1005 in the menu screen SC100 illustrated in FIG. 13, and is allowed to login. As the usage volume count screen SC700, firstly, a screen illustrated in FIG. 22(a) is displayed. In the screen illustrated in FIG. 22(a), when the user inputs a service ID in a textbox 7001 and presses a “count” button 7002, a usage volume counting request is received by the request receiver 11 of the device management apparatus 10. Then, the usage volume counting request is sent along with the specified service ID to the usage history manager 17.

The usage history manager 17 counts the usage volume from all sets of history information corresponding to the specified service ID in response to the usage volume counting request. Consequently, the usage volume count screen SC700 undergoes a transition from the screen illustrated in FIG. 22(a) to a screen illustrated in FIG. 22(b) and the result of usage volume counting as obtained by the usage history manager 17 is notified to the user. When the user presses a “return” button 7011 provided in the screen illustrated in FIG. 22(b), the display returns to the menu screen SC100 illustrated in FIG. 13. However, in the screen illustrated in FIG. 22(b), if the user presses an “end” button 7012, then the display of the interface screen is ended.

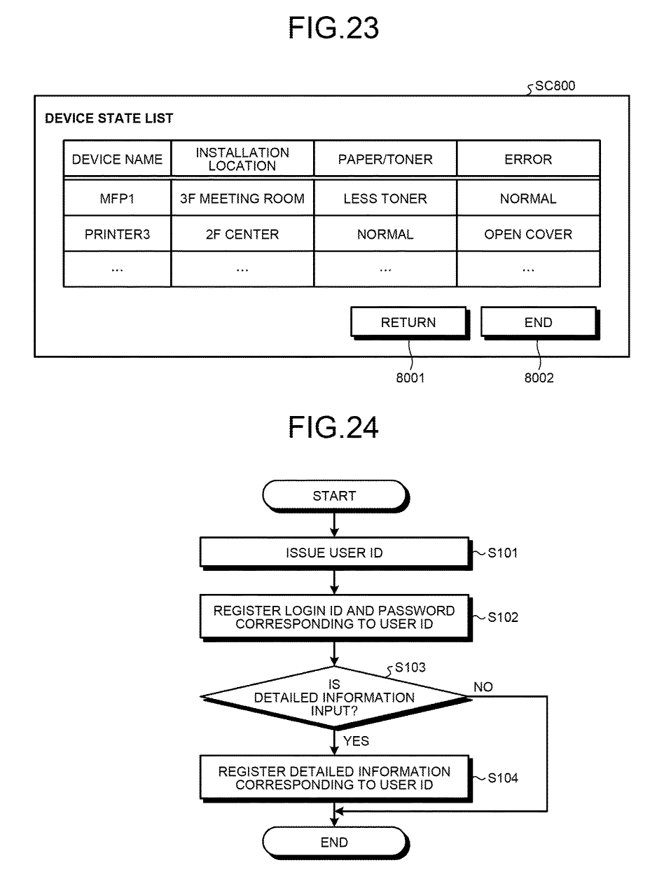

FIG. 23 is a diagram illustrating an example of a device state list screen SC800 that is displayed when the user presses the “device state list” button 1006 provided in the menu screen SC100 illustrated in FIG. 13, and is allowed to login. When the user presses the “device state list” button 1006 in the menu screen SC100 illustrated in FIG. 13 and is allowed to login, a device state list request is received by the request receiver 11 of the device management apparatus 10. Then, the device state list request is sent along with the user ID to the state manager 18. Subsequently, in response to the device state list request, the state manager 18 collects the state information of all devices 20 used by the user. As a result, the device state list screen SC800 illustrated in FIG. 23 is displayed, and a list of states of the devices 20 is displayed. When the user presses a “return” button 8001 provided in the device state list screen SC800 illustrated in FIG. 23, the display returns to the menu screen SC100 illustrated in FIG. 13. However, in the device state list screen SC800 illustrated in FIG. 23, if the user presses an “end” button 8002, then the display of the interface screen is ended.

Meanwhile, the configuration of the interface screens described above is only exemplary, and it is not the only possible configuration. As long as the interface screens provided by the request receiver 11 of the device management apparatus 10 enable the user to input various requests to the device management apparatus 10, the exemplary configuration described above can be modified or changed in various forms.

Explanation of Operations

Specific examples of main operations performed in the device management system 1 according to the first embodiment are described below with reference to the accompanying flowcharts and sequence diagrams.

FIG. 24 is a flowchart for explaining an example of operations performed during a user registration operation. The operations illustrated in the flowchart in FIG. 24 are performed by the user manager 12 in response to the reception of a user registration request from the request receiver 11.

Upon receiving a user registration request from the request receiver 11, firstly, the user manager 12 issues a user ID (Step S101). Then, the user manager 12 registers the login ID and the password, which are received along with the user registration request, in a corresponding manner to the user ID issued at Step S101 (Step S102).

Subsequently, the user manager 12 determines whether or not detailed information was received along with the user registration request, that is, determines whether or not the user has input detailed information (Step S103). If the detailed information has been input (Yes at Step S103), then the user manager 12 registers the detailed information, which is received along with the user registration request, in a corresponding manner to the user ID issued at Step S101 (Step S104) and ends the user registration operation. On the other hand, if the detailed information has not been input (No at Step S103), then it marks the end of the user registration operation.

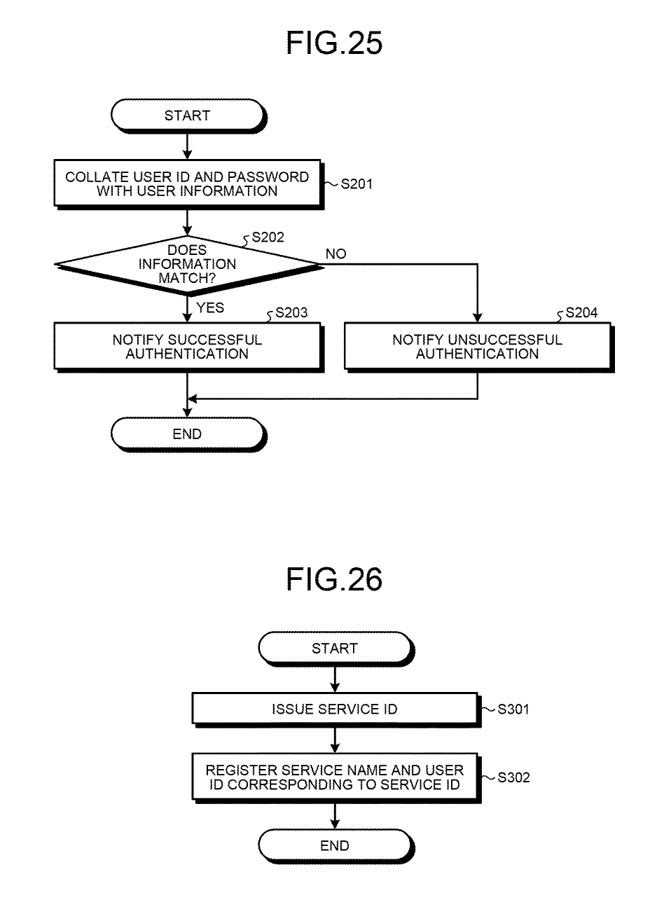

FIG. 25 is a flowchart for explaining an example of operations performed during an authentication operation. The operations illustrated in the flowchart in FIG. 25 are performed by the user manager 12 in response to the reception of a login request from the request receiver 11.

Upon receiving the login request from the request receiver 11, the user manager 12 collates the login ID and the password, which are received along with the login request, with the user information (Step S201) and determines whether or not an identical login ID and an identical password are present in the user information (Step S202). If an identical login ID and an identical password are present (Yes at Step S202), then the user manager 12 notifies the request receiver 11 that authentication is successful (Step S203) and ends the authentication operation. On the other hand, if an identical login ID and an identical password are not present (No at Step S202), then the user manager 12 notifies the request receiver 11 that authentication is unsuccessful (Step S204) and ends the authentication operation.

FIG. 26 is a flowchart for explaining an example of operations performed during a service purchase operation. The operations illustrated in the flowchart in FIG. 26 are performed by the service manager 13 in response to the reception of a service purchase request from the request receiver 11.

Upon receiving the service purchase request from the request receiver 11, the service manager 13 issues a service ID (Step S301). Then, the service manager 13 registers the service name and the user ID, which are received along with the service purchase request, in a corresponding manner to the service ID issued at Step S301 (Step S302) and ends the service purchase operation.

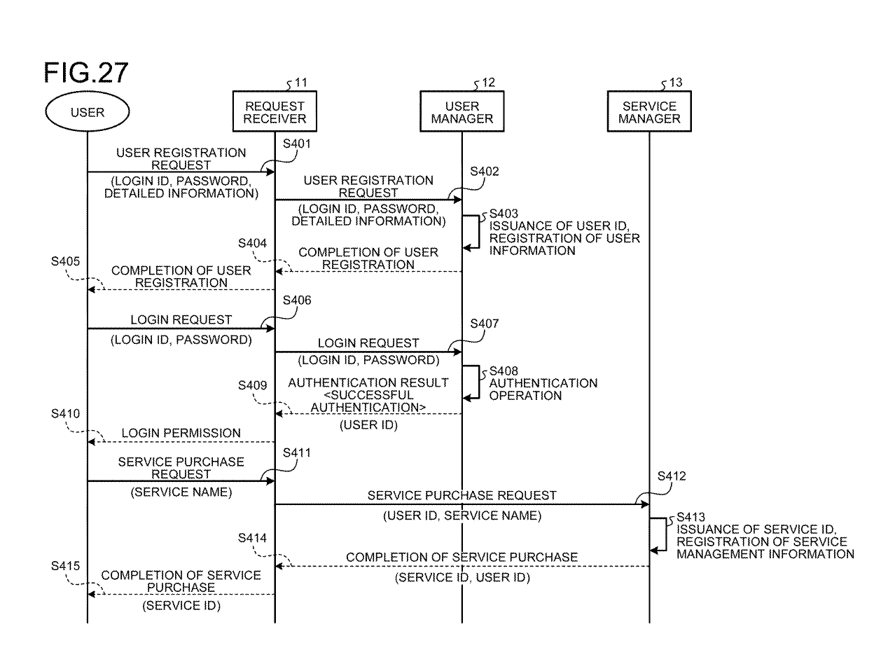

FIG. 27 is a sequence diagram for explaining an example of operations starting from a user registration operation to a service purchase operation. The sequence diagram illustrated in FIG. 27 represents an example of operations performed by the request receiver 11, the user manager 12, and the service manager 13 in response to a user registration request, a login request, and a service purchase request, respectively, issued by the user.

A user registration request issued by the user is received by the request receiver 11 (Step S401). Upon receiving the user registration request, the request receiver 11 sends it to the user manager 12 (Step S402). The user registration request is attached with the login ID, the password, and the detailed information input by the user.

Upon receiving the user registration request from the request receiver 11, the user manager 12 issues a user ID and registers the user information (Step S403). Then, the user manager 12 notifies the request receiver 11 about the completion of the user registration (Step S404). Upon receiving the notification about the completion of the user registration from the user manager 12, the request receiver 11 notifies the user about the completion of the user registration (Step S405).

Subsequently, when the user issues a login request, the request receiver 11 receives the login request (Step S406). Upon receiving the login request, the request receiver 11 sends it to the user manager 12 (Step S407). The login request is attached with the login ID and the password input by the user.

Upon receiving the login request from the request receiver 11, the user manager 12 performs an authentication operation (Step S408). Then, the user manager 12 notifies the request receiver 11 about the authentication result (Step S409). Herein, the authentication result is assumed to indicate that the authentication is successful. The authentication result indicating successful authentication is attached with the user ID of the user whose authentication is successful. Upon receiving the authentication result indicating successful authentication from the user manager 12, the request receiver 11 allows the user to login (Step S410).

Subsequently, when the user issues a service purchase request, the request receiver 11 receives the service purchase request (Step S411). Upon receiving the service purchase request, the request receiver 11 sends it to the service manager 13 (Step S412). The service purchase request is attached with the user ID and the service name.

Upon receiving the service purchase request from the request receiver 11, the service manager 13 issues a service ID and registers service management information (Step S413). Then, the service manager 13 notifies the request receiver 11 about the completion of the service purchase (Step S414). This notification is attached with the service ID issued by the service manager 13, and the user ID. Upon receiving the notification about the completion of the service purchase from the service manager 13, the request receiver 11 notifies the user about the completion of the service purchase (Step S415). This notification is attached with the service ID issued by the service manager 13.

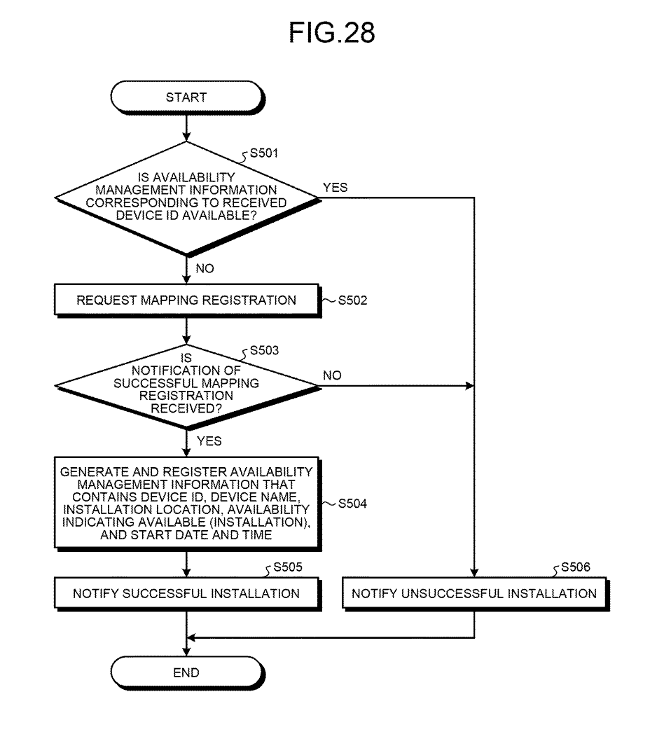

FIG. 28 is a flowchart for explaining an example of operations performed during an installation registration operation. The operations illustrated in the flowchart in FIG. 28 are performed by the device availability manager 14 in response to the reception of an installation registration request from the request receiver 11.

Upon receiving the installation registration request from the request receiver 11, the device availability manager 14 firstly confirms whether or not availability management information is available corresponding to the device ID received along with the installation registration request (Step S501). If availability management information is not available corresponding to the received device ID (No at Step S501), then the device availability manager 14 requests the mapping manager 15 to perform mapping registration (Step S502).

When a response indicating successful mapping registration is received from the mapping manager 15 (Yes at Step S503), the device availability manager 14 generates and registers availability management information that contains the device ID, the device name, and the installation location received along with the installation registration request as well as contains availability indicating available (installation) and the start date and time (Step S504). Then, the device availability manager 14 notifies the request receiver 11 about successful installation (Step S505) and ends the installation registration operation.

Meanwhile, if availability management information is available corresponding to the received device ID (Yes at Step S501) or if a notification about unsuccessful mapping registration is received from the mapping manager 15 (No at Step S503), then the device availability manager 14 notifies the request receiver 11 about unsuccessful installation (Step S506) and ends the installation registration operation.

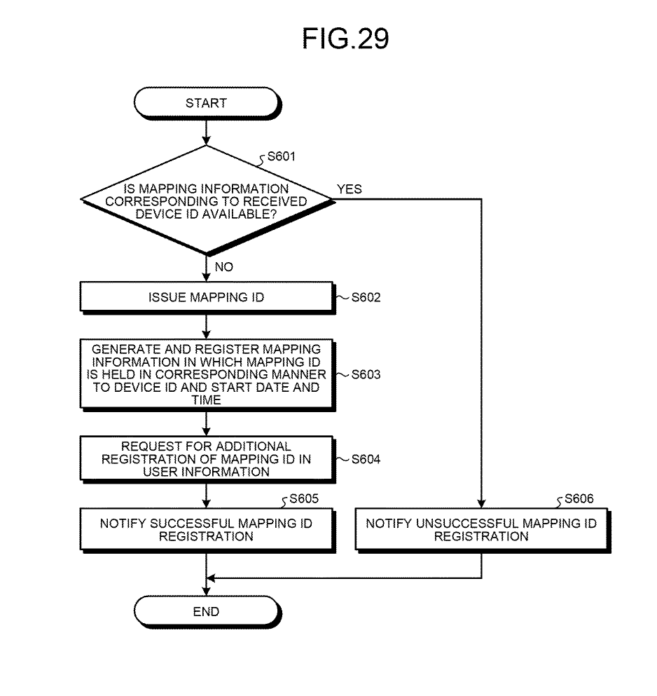

FIG. 29 is a flowchart for explaining an example of operations performed during a mapping registration operation. The operations illustrated in the flowchart in FIG. 29 are performed by the mapping manager 15 in response to the reception of a mapping registration request from the device availability manager 14.

Upon receiving the mapping registration request from the device availability manager 14, the mapping manager 15 firstly confirms whether or not mapping information is available corresponding to the device ID received along with the mapping registration request (Step S601). If mapping information is not available corresponding to the received device ID (No at Step S601), then the mapping manager 15 issues a mapping ID (Step S602), and generates and registers mapping information in which the mapping ID is associated with the device ID and the start date and time received along with the mapping registration request (Step S603).

Then, the mapping manager 15 requests the user manager 12 to additionally register the mapping ID in the user information (Step S604); notifies the device availability manager 14 about successful mapping registration (Step S605); and ends the mapping registration operation.

Meanwhile, if mapping information is available corresponding to the received device ID (Yes at Step S601), then the mapping manager 15 notifies the device availability manager 14 about unsuccessful mapping registration (Step S606) and ends the mapping registration operation.

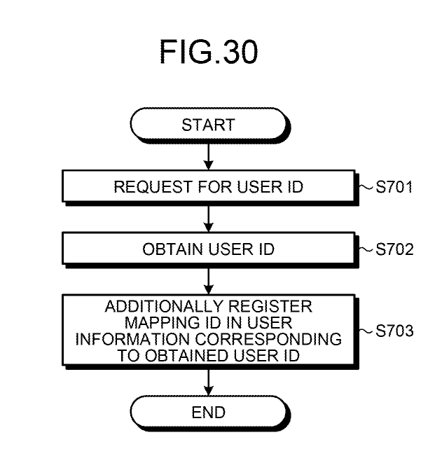

FIG. 30 is a flowchart for explaining an example of operations performed during a mapping ID additional-registration operation. The operations illustrated in the flowchart in FIG. 30 are performed by the user manager 12 in response to the reception of a request for additional registration of a mapping ID (i.e., a mapping ID registration request) from the mapping manager 15.

Upon receiving the mapping ID registration request from the mapping manager 15, firstly, the user manager 12 requests the service manager 13 for the user ID corresponding to the service ID that is received along with the mapping ID registration request (Step S701), and obtains the user ID from the service manager 13 (Step S702). Then, the user manager 12 additionally registers the mapping ID, which is received along with the mapping ID registration request, in the user information corresponding to the user ID obtained from the service manager 13 (Step S703), and ends the mapping ID additional-registration operation.

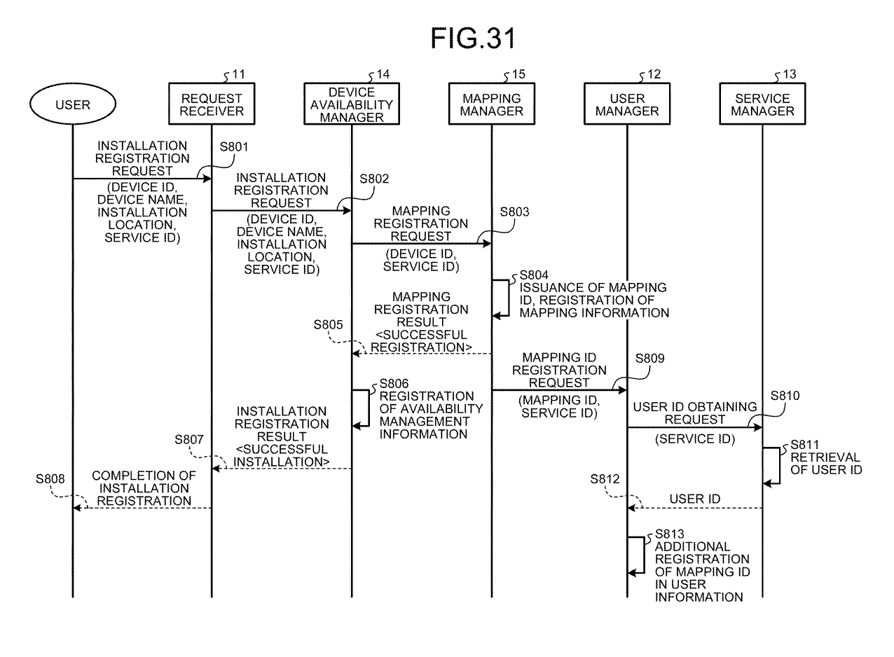

FIG. 31 is a sequence diagram for explaining an example of operations performed during an installation registration operation including a mapping registration operation and a mapping ID additional-registration operation. The sequence diagram illustrated in FIG. 31 represents an example of operations performed by the request receiver 11, the device availability manager 14, the mapping manager 15, the user manager 12, and the service manager 13 (an example of operations in the case of successful installation registration) in response to a user registration request issued by the user.

The installation registration request issued by the user is received by the request receiver 11 (Step S801). Upon receiving the installation registration request, the request receiver 11 sends it to the device availability manager 14 (Step S802). The installation registration request is attached with the device ID, the device name, and the installation location of the device 20 to be installed, as well as with the service ID.

Upon receiving the installation registration request from the request receiver 11, the device availability manager 14 requests the mapping manager 15 to perform mapping registration (Step S803). The mapping registration request is attached with the device ID and the service ID that are received along with the installation registration request by the device availability manager 14 from the request receiver 11. Upon receiving the mapping registration request from the device availability manager 14, the mapping manager 15 issues a mapping ID, and generates and registers mapping information (Step S804). Then, the mapping manager 15 notifies the device availability manager 14 about the mapping registration result indicating successful registration (Step S805).

Upon receiving the mapping registration result indicating successful registration from the mapping manager 15, the device availability manager 14 generates and registers availability management information in response to the installation registration request (Step S806). Then, the device availability manager 14 notifies the request receiver 11 about an installation registration result indicating successful installation (Step S807). Upon receiving the installation registration result indicating successful installation from the device availability manager 14, the request receiver 11 notifies the user about the completion of the installation registration (Step S808).

Moreover, after notifying the device availability manager 14 at Step S805 about the mapping registration result indicating successful registration, the mapping manager 15 requests the user manager 12 to additionally register a mapping ID (Step S809). The mapping ID registration request is attached with the mapping ID, which is issued by the mapping manager 15, and the service ID, which is received along with the mapping registration request by the mapping manager 15 from the device availability manager 14.

Upon receiving the mapping ID registration request from the mapping manager 15, the user manager 12 requests the service manager 13 to obtain the user ID (Step S810). The user ID obtaining request is attached with the service ID that is received along with the mapping ID registration request by the user manager 12 from the mapping manager 15. Upon receiving the user ID obtaining request from the user manager 12, the service manager 13 searches the service management information for the user ID corresponding to the service ID attached to the user ID obtaining request (Step S811) and sends the retrieved user ID to the user manager 12 (Step S812). Then, the user manager 12 additionally registers the mapping ID in the user information corresponding to the user ID received from the service manager 13 (Step S813).

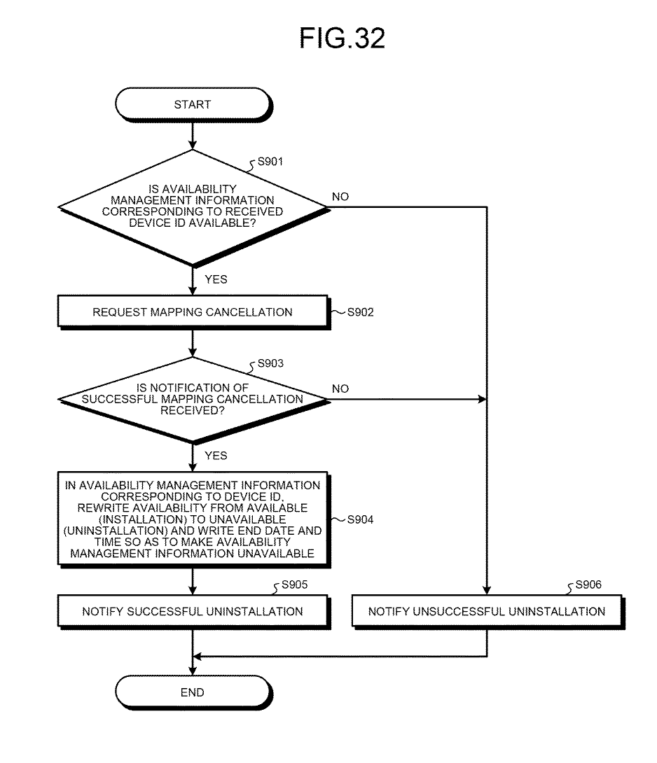

FIG. 32 is a flowchart for explaining an example of operations performed during an uninstallation registration operation. The operations illustrated in the flowchart in FIG. 32 are performed by the device availability manager 14 in response to the reception of an uninstallation registration request from the request receiver 11.

Upon receiving the uninstallation registration request from the request receiver 11, the device availability manager 14 confirms whether or not availability management information is available corresponding to the device ID received along with the uninstallation registration request (Step S901). If availability management information is available corresponding to the received device ID (Yes at Step S901), then the device availability manager 14 requests the mapping manager 15 to perform mapping cancellation (Step S902).

When a response indicating successful mapping cancellation is received from the mapping manager 15 (Yes at Step S903), the device availability manager 14 rewrites available (installation) to unavailable (uninstallation) as well as writes the end date and time in the availability management information corresponding to the device ID received along with the replacement registration request, and thus makes the availability management information unavailable (Step S904). Then, the device availability manager 14 notifies the request receiver 11 about successful uninstallation (Step S905) and ends the uninstallation registration operation.

Meanwhile, if availability management information of the available nature is not available corresponding to the device ID received along with the uninstallation registration request (No at Step S901) or if a response indicating unsuccessful mapping uninstallation is received from the mapping manager 15 (No at Step S903), then the device availability manager 14 notifies the request receiver 11 about unsuccessful uninstallation (Step S906) and ends the uninstallation registration operation.

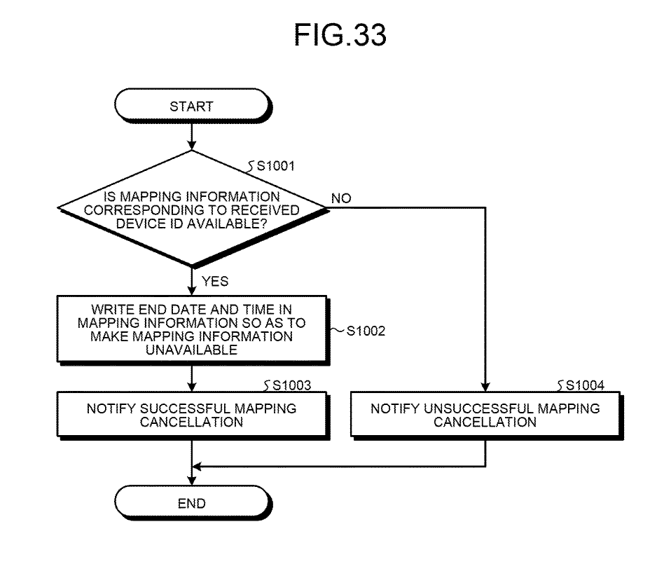

FIG. 33 is a flowchart for explaining an example of operations performed during a mapping cancellation operation. The operations illustrated in the flowchart in FIG. 33 are performed by the mapping manager 15 in response to the reception of a mapping cancellation request from the device availability manager 14.

Upon receiving the mapping cancellation request from the device availability manager 14, firstly, the mapping manager 15 confirms whether or not mapping information is available corresponding to the device ID received along with the mapping cancellation request (Step S1001). If mapping information is available corresponding to the device ID (Yes at Step S1001), then the mapping manager 15 writes the end date and time in the mapping information and makes the mapping information unavailable (Step S1002). Then, the mapping manager 15 notifies the device availability manager 14 about successful mapping cancellation (Step S1003) and ends the mapping cancellation operation.

Meanwhile, if mapping information is not available corresponding to the device ID (No at Step S1001), then the mapping manager 15 notifies the device availability manager 14 about unsuccessful mapping cancellation (Step S1004) and ends the mapping cancellation operation.

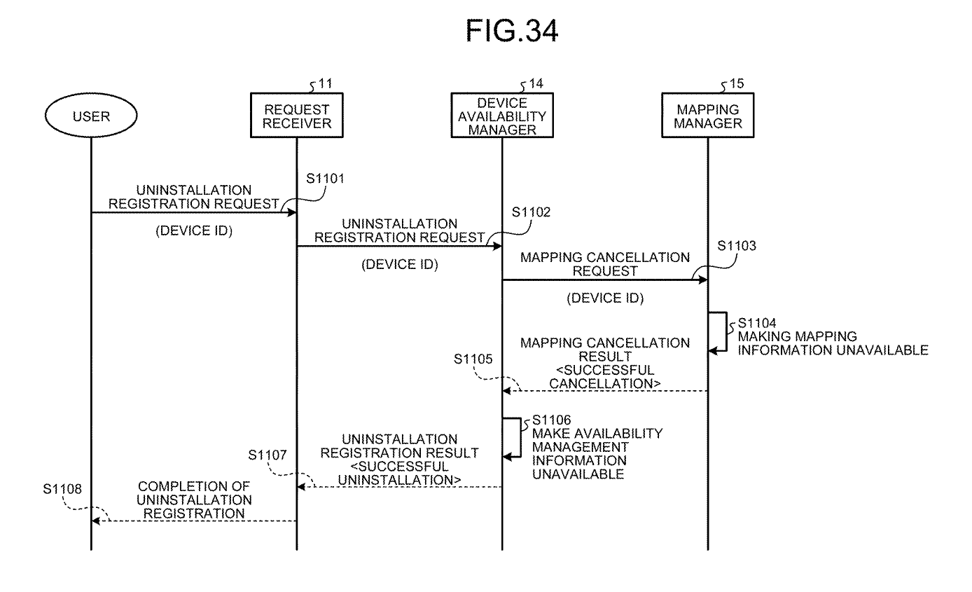

FIG. 34 is a sequence diagram for explaining an example of operations performed during an uninstallation registration operation including a mapping cancellation operation. The sequence diagram illustrated in FIG. 34 represents an example of operations performed by the request receiver 11, the device availability manager 14, and the mapping manager 15 (an example of operations in the case of successful uninstallation registration) in response to an uninstallation registration request issued by the user.

The uninstallation registration request issued by the user is received by the request receiver 11 (Step S1101). Upon receiving the uninstallation registration request, the request receiver 11 sends it to the device availability manager 14 (Step S1102). The uninstallation registration request is attached with the device ID of the device 20 to be uninstalled.

Upon receiving the uninstallation registration request from the request receiver 11, the device availability manager 14 requests the mapping manager 15 to perform mapping cancellation (Step S1103). The mapping cancellation request is attached with the device ID that is received along with the uninstallation registration request by the device availability manager 14 from the request receiver 11. Upon receiving the mapping cancellation request from the device availability manager 14, the mapping manager 15 makes the mapping information, which corresponds to the device ID received along with the mapping cancellation request, unavailable (Step S1104). Then, the mapping manager 15 notifies the device availability manager 14 about the mapping cancellation result indicating successful cancellation (Step S1105).

Upon receiving the mapping cancellation result indicating successful cancellation from the mapping manager 15, the device availability manager 14 makes the availability management information, which corresponds to the device ID received along with the mapping cancellation request, unavailable (Step S1106). Then, the device availability manager 14 notifies the request receiver 11 about an uninstallation registration result indicating successful uninstallation (Step S1107). Upon receiving the uninstallation registration result indicating successful uninstallation from the device availability manager 14, the request receiver 11 notifies the user about the completion of the uninstallation registration (Step S1108).

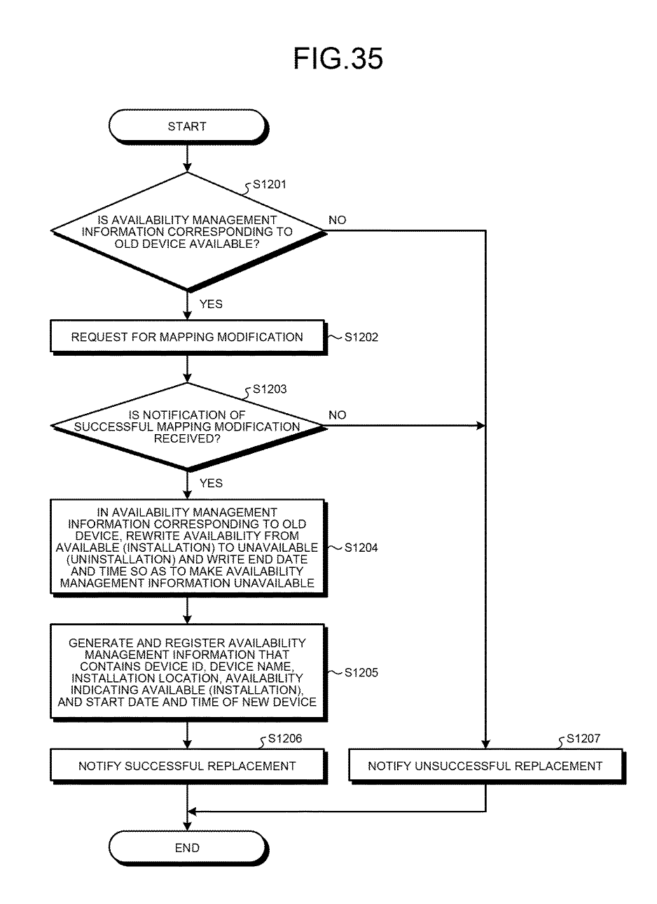

FIG. 35 is a flowchart for explaining an example of operations performed during a replacement registration operation. The operations illustrated in the flowchart in FIG. 35 are performed by the device availability manager 14 in response to the reception of a replacement registration request from the request receiver 11.

Upon receiving the replacement registration request from the request receiver 11, firstly, the device availability manager 14 confirms, based on the device name and the installation location of the old device as received along with the replacement registration request, whether or not availability management information corresponding to the old device is available (Step S1201). If availability management information is available corresponding to the old device (Yes at Step S1201), then the device availability manager 14 requests the mapping manager 15 to make mapping modification (Step S1202).

Subsequently, if a response indicating successful mapping modification is received from the mapping manager 15 (Yes at Step S1203), then the device availability manager 14 rewrites available (installation) to unavailable (uninstallation) as well as writes the end date and time in the availability management information corresponding to the old device, and thus makes the availability management information unavailable (Step S1204). Moreover, the device availability manager 14 generates and registers availability management information that corresponds to the new device and contains the following: the device ID of the new device as received along with the replacement registration request; the device name and the installation location of the old device as received along with the replacement registration request; availability indicating available (installation); and the start date and time (Step S1205). Then, the device availability manager 14 notifies the request receiver 11 about successful replacement (Step S1206) and ends the replacement registration operation.

Meanwhile, if availability management information is not available corresponding to the old device (No at Step S1201) or if a response indicating unsuccessful mapping modification is received from the mapping manager 15 (No at Step S1203), then the device availability manager 14 notifies the request receiver 11 about unsuccessful replacement (Step S1207) and ends the replacement registration operation.

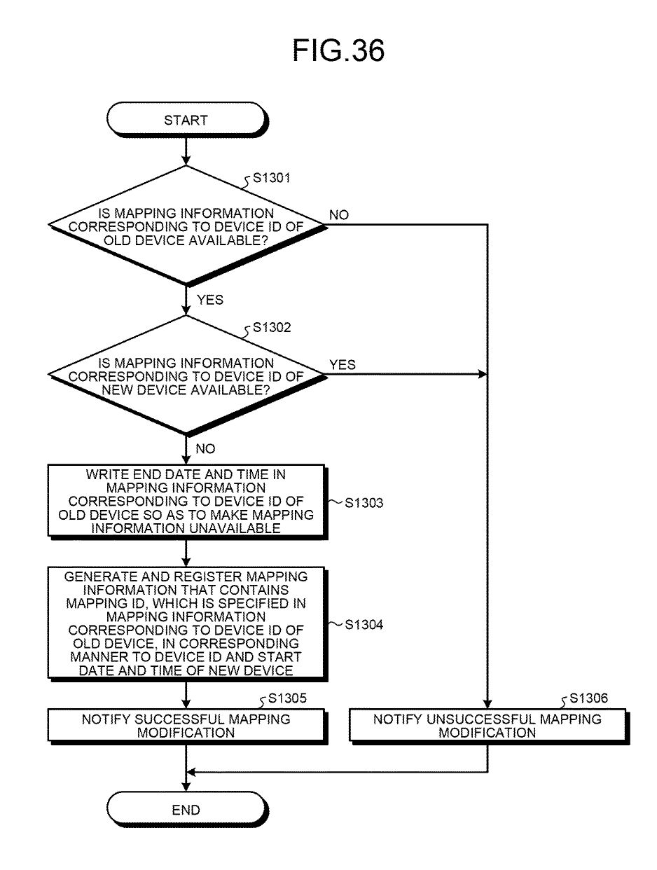

FIG. 36 is a flowchart for explaining an example of operations performed during a mapping modification operation. The operations illustrated in the flowchart in FIG. 36 are performed by the mapping manager 15 in response to the reception of a mapping modification request from the device availability manager 14.

Upon receiving the mapping modification request from the device availability manager 14, firstly, the mapping manager 15 confirms whether or not mapping information is available corresponding to the device ID of the old device as received along with the mapping modification request (Step S1301). If mapping information is available corresponding to the device ID of the old device (Yes at Step S1301), then the mapping manager 15 further confirms whether or not mapping information is available corresponding to the device ID of the new device as received along with the mapping modification request (Step S1302).

If mapping information is not available corresponding to the device ID of the new device (No at Step S1302); then, firstly, the mapping manager 15 writes the end date and time in the mapping information corresponding to the device ID of the old device and makes that mapping information unavailable (Step S1303). Subsequently, the mapping manager 15 generates and registers mapping information in which the device ID and the start date and time of the new device are associated with the mapping ID included in the mapping information corresponding to the device ID of the old device, that is, the mapping ID specified in the mapping information that has been made unavailable at Step S1303 (Step S1304). Then, the mapping manager 15 notifies the device availability manager 14 about successful mapping modification (Step S1305) and ends the mapping modification operation.

Meanwhile, if mapping information is not available corresponding to the device ID of the old device (No at Step S1301) or if mapping information is available corresponding to the device ID of the new device (Yes at Step S1302), then the mapping manager 15 notifies the device availability manager 14 about unsuccessful mapping modification (Step S1306) and ends the mapping modification operation.

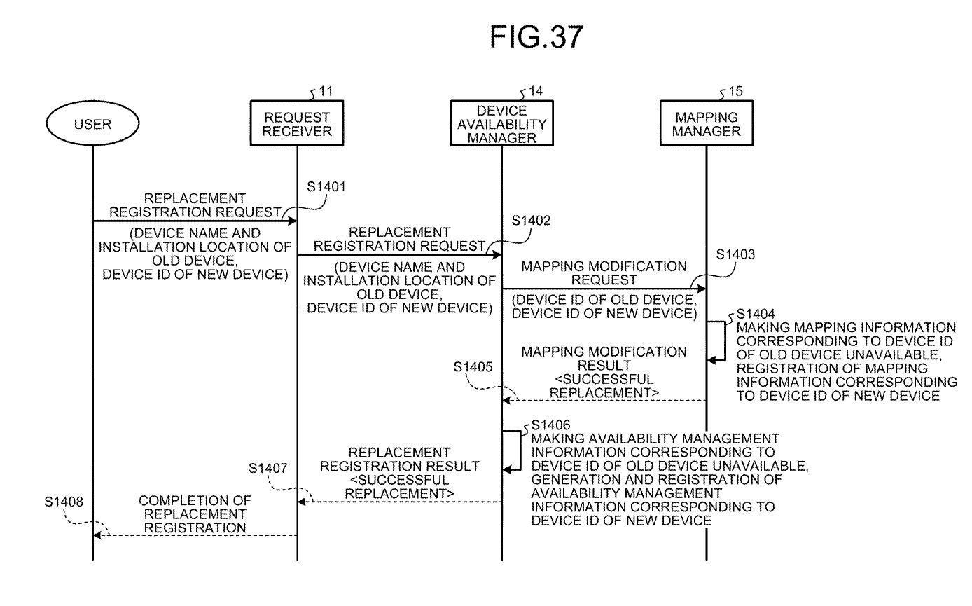

FIG. 37 is a sequence diagram for explaining an example of operations performed during a replacement registration operation including a mapping modification operation. The sequence diagram illustrated in FIG. 37 represents an example of operations performed by the request receiver 11, the device availability manager 14, and the mapping manager 15 (an example of operations in the case of successful replacement registration) in response to a replacement registration request issued by the user.

The replacement registration request issued by the user is received by the request receiver 11 (Step S1401). Upon receiving the replacement registration request, the request receiver 11 sends it to the device availability manager 14 (Step S1402). The replacement registration request is attached with the device name and the installation location of the old device 20 as well as with the device ID of the new device.

Upon receiving the replacement registration request from the request receiver 11, the device availability manager 14 requests the mapping manager 15 to perform mapping modification (Step S1403). The mapping modification request is attached with the device ID of the old device and the device ID of the new device. Upon receiving the mapping modification request from the device availability manager 14, the mapping manager 15 makes the mapping information corresponding to the device ID of the old device unavailable, and generates and registers mapping information corresponding to the device ID of the new device (Step S1404). Then, the mapping manager 15 notifies the device availability manager 14 about a mapping modification result indicating successful mapping modification (Step S1405).

Upon receiving the mapping modification result indicating successful mapping modification from the mapping manager 15, the device availability manager 14 makes the availability management information corresponding to the old device unavailable, and generates and registers availability management information corresponding to the new device (Step S1406). Then, the device availability manager 14 notifies the request receiver 11 about a replacement registration result indicating successful replacement (Step S1407). Upon receiving the replacement registration result indicating successful replacement from the device availability manager 14, the request receiver 11 notifies the user about the completion of the replacement registration (Step S1408).

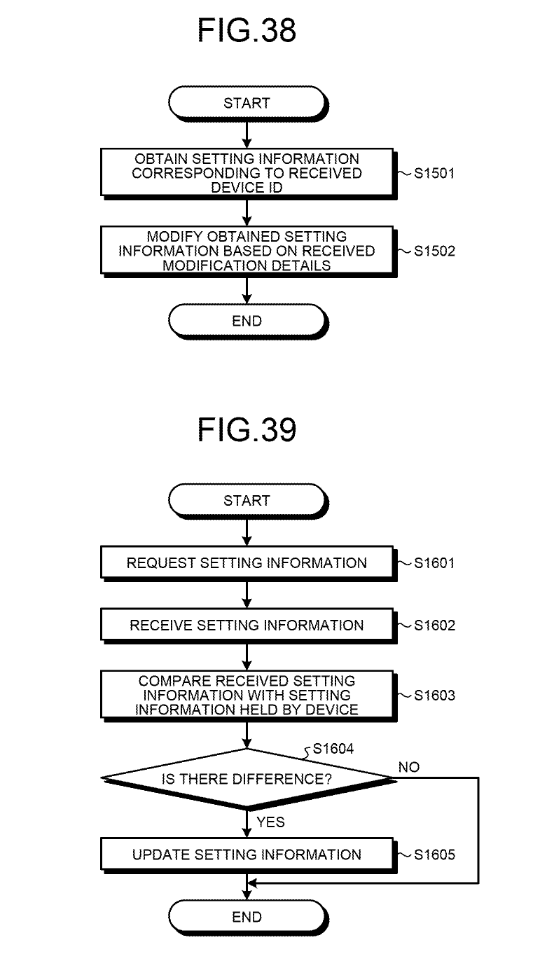

FIG. 38 is a flowchart for explaining an example of operations performed during a setting modification operation. The operations illustrated in the flowchart in FIG. 38 are performed by the setting manager 16 in response to the reception of a setting modification request from the request receiver 11.

Upon receiving the setting modification request from the request receiver 11, firstly, the setting manager 16 obtains setting information corresponding to the device ID received along with the setting modification request (Step S1501). Then, the setting manager 16 modifies the setting information, which is obtained at Step S1501, based on the modification details received along with the setting modification request (Step S1502) and ends the setting modification operation. The modified setting information is reflected in the device 20 when a setting synchronization operation (described below) is performed.

FIG. 39 is a flowchart for explaining an example of operations performed during a setting synchronization operation in the device 20. The operations illustrated in the flowchart in FIG. 39 are performed by the setting synchronizer 23 of the device 20 on a periodic basis or at predetermined timings.

During the setting synchronization operation, firstly, the setting synchronizer 23 of the device 20 requests the device management apparatus 10 for setting information (Step S1601) and receives the setting information sent by the device management apparatus 10 in response to the request (Step S1602). Then, the setting synchronizer 23 compares the setting information, which is received at Step S1602, with the setting information stored in the device 20 (Step S1603). Herein, the setting information stored in the device 20 represents the current settings of the device 20.

If the result of the comparison performed at Step S1603 indicates a difference between the setting information received from the device management apparatus 10 and the setting information stored in the device 20 (Yes at Step S1604); then the setting synchronizer 23 reflects the difference in the settings of the device 20 and updates the setting information stored in the device 20 (Step S1605), and ends the setting synchronization operation. On the other hand, if there is no difference between the setting information received from the device management apparatus 10 and the setting information stored in the device 20 (No at Step S1604), then the setting synchronizer 23 ends the setting synchronization operation as it is.

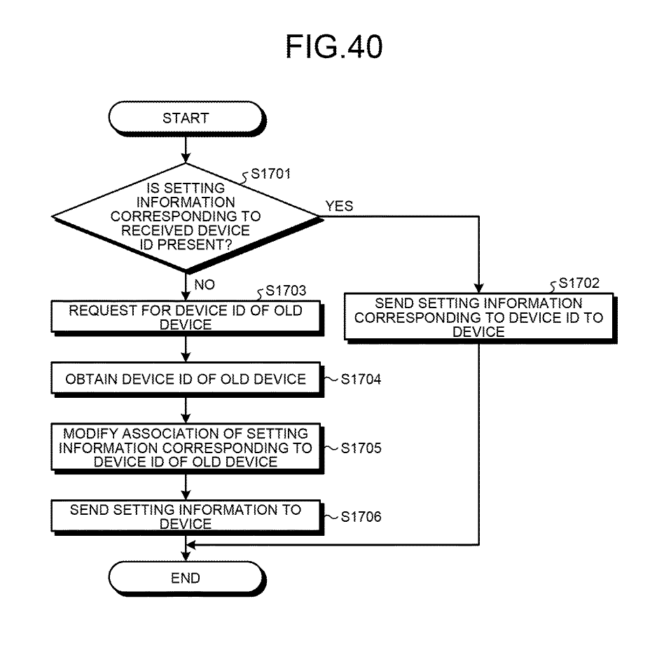

FIG. 40 is a flowchart for explaining an example of operations performed during a setting synchronization operation in the device management apparatus 10. The operations illustrated in the flowchart in FIG. 40 are performed by the setting manager 16 in the device management apparatus 10 in response to the reception of a request for setting information from the device 20.

Upon receiving the request for setting information from the device 20, the setting manager 16 in the device management apparatus 10 confirms whether or not setting information is present corresponding to the device ID received along with the request for setting information (Step S1701). If setting information is present corresponding to the received device ID (Yes at Step S1701), then the setting manager 16 sends the setting information corresponding to that device ID to the device 20 (Step S1702) and ends the setting synchronization operation.

On the other hand, if setting information is not present corresponding to the received device ID (No at Step S1701), then the setting manager 16 requests the mapping manager 15 for the device ID of the old device (Step S1703). That is, in the case in which the setting manager 16 stores the setting information of the device 20 that is in the installation state but in which the old device is replaced by a new device as a result of the replacement of the device 20 as described earlier, the setting manager 16 is storing the setting information of the old device but is not storing the setting information of the new device. In that case, in order to identify the setting information of the old device, the setting manager 16 requests the mapping manager 15 for the device ID of the old device.

When the mapping manager 15 receives the device ID of the old device, the setting manager 16 obtains the device ID of the old device (Step S1704) and associates the setting information corresponding to the device ID of the old device with the device ID of the new device, that is, with the device ID received from the device 20 along with the request for setting information (Step S1705). Then, the setting manager 16 sends the setting information, which is subjected to association modification to correspond to the device ID of the new device, to the device 20 that issued the request (Step S1706) and ends the setting synchronization operation.

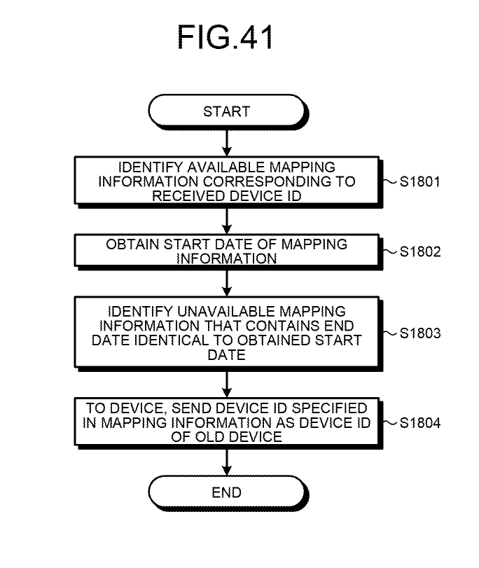

FIG. 41 is a flowchart for explaining an example of operations performed during an old-device-ID search operation. The operations illustrated in the flowchart in FIG. 41 are performed by the mapping manager 15 in response to the reception of a request for the device ID of an old device from the setting manager 16.

Upon receiving the request for the device ID of an old device from the setting manager 16, firstly, the mapping manager 15 identifies available mapping information corresponding to the received device ID (Step S1801). Then, the mapping manager 15 obtains the start date and time of the mapping information identified at Step S1801 (Step S1802), and identifies unavailable mapping information containing the end date and time that is identical to the obtained start date and time (Step S1803). Subsequently, the mapping manager 15 sends the device ID included in the mapping information identified at Step S1803 as the device ID of the old device to the device 20 that issued the request (Step S1804) and ends the old-device-ID search operation. As a result of performing a setting synchronization operation including the old-device-ID search operation, in the case in which a device 20 is replaced, the user can be enabled to continually use the setting information of the old device without having to perform any particular operation.

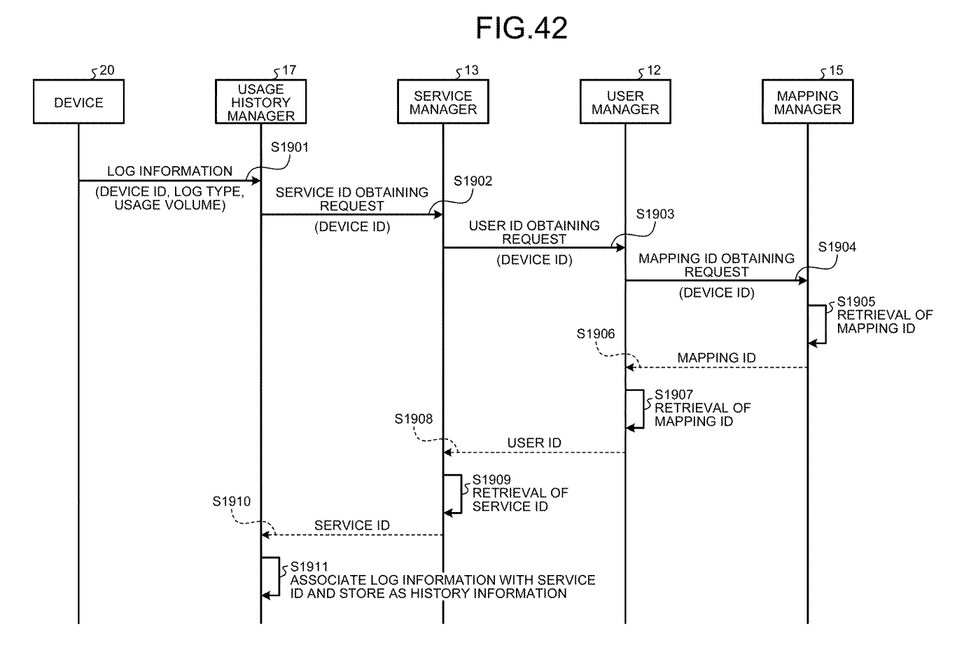

FIG. 42 is a sequence diagram for explaining an example of operations performed during a history information storing operation. The sequence diagram illustrated in FIG. 42 represents an example of operations performed by the usage history manager 17, the service manager 13, the user manager 12, and the mapping manager 15 in the case in which a job such as a printing job or a scanning job is executed in the device 20 and log information related to that job is sent from the device 20.

The log information sent from the device 20 is received by the usage history manager 17 of the device management apparatus 10 (Step S1901). The log information contains the device ID, the log type, and the usage volume. Upon receiving the log information from the device 20, in order to obtain the service ID corresponding to the device 20 that sent the log information, the usage history manager 17 requests the service manager 13 to obtain the service ID (Step S1902). The service ID obtaining request is attached with the device ID of the device 20 that sent the log information.

Upon receiving the service ID obtaining request from the usage history manager 17, in order to obtain the user ID corresponding to the service ID requested by the usage history manager 17, the service manager 13 requests the user manager 12 to obtain the user ID (Step S1903). The user ID obtaining request is attached with the device ID of the device 20 that sent the log information.

Upon receiving the user ID obtaining request from the service manager 13, in order to obtain the mapping ID corresponding to the user ID requested by the user manager 12, the user manager 12 requests the mapping manager 15 to obtain the mapping ID (Step S1904). The mapping ID obtaining request is attached with the device ID of the device 20 that sent the log information.

Upon receiving the mapping ID obtaining request from the user manager 12, the mapping manager 15 searches the mapping information for the mapping ID corresponding to the device ID of the device that sent the log information (Step S1905). Then, the mapping manager 15 sends the obtained ID to the user manager 12 (Step S1906).

Upon receiving the mapping ID from the mapping manager 15, the user manager 12 searches the user information for the user ID corresponding to the mapping ID received from the mapping manager 15 (Step S1907). Then, the user manager 12 sends the obtained user ID to the service manager 13 (Step S1908).

Upon receiving the user ID from the user manager 12, the service manager 13 searches the service management information for the service ID corresponding to the user ID received from the user manager 12 (Step S1909). Then, the service manager 13 sends the obtained service ID to the usage history manager 17 (Step S1910).

Upon receiving the service ID from the service manager 13, the usage history manager 17 associates the log information received from the device 20 with the service ID received from the service manager 13, and stores that information as history information (Step S1911). As a result of performing the history information storing operation described above, the usage history manager 17 can manage the usage history of services, such as the printing service and the scanning service performed using the devices 20, not on the basis of the devices 20 but on the basis of the services purchased by the users. Moreover, even if a device 20 is replaced, since the association between the device ID of the old device and the service ID is continually used as the association between the device ID of the new device and the service ID by making use of the mapping ID and the user ID, the usage volume can be counted in a consistent manner in the old device and the new device.

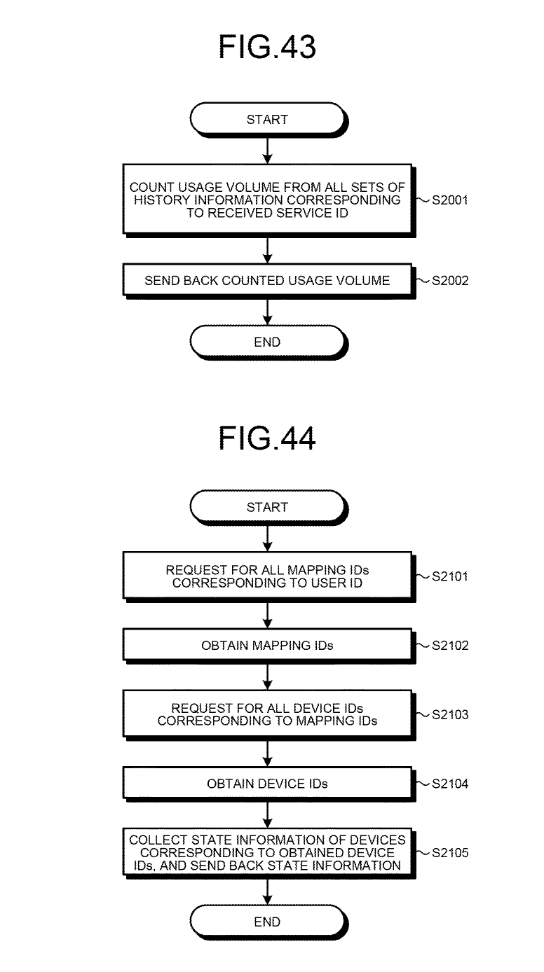

FIG. 43 is a flowchart for explaining an example of operations performed during a usage volume counting operation. The operations illustrated in the flowchart in FIG. 43 are performed by the usage history manager 17 in response to the reception of a usage volume counting request from the request receiver 11.

Upon receiving the usage volume counting request from the request receiver 11, firstly, the usage history manager 17 obtains all sets of history information corresponding to the service ID received along with the usage volume counting request and counts the usage volume specified in those sets of history information (Step S2001). Then, the usage history manager 17 sends the counted usage volume to the request receiver 11 (Step S2002). The result of usage volume counting is displayed in the usage volume count screen SC700 (see FIG. 22) in a viewable manner for the user.

Meanwhile, in the first embodiment, it is assumed that the usage history manager 17 stores the history information of only the target period of time for charging (for example, the present month) and deletes the history information of the services for which the charging operation has ended. However, alternatively, the configuration can be such that the usage history manager 17 stores the history information also of the services for which the charging operation has ended. In that case, the usage history manager 17 can collect the history information during a period of time including the point of time of receiving a usage volume counting request, and then count the usage volume.

FIG. 44 is a flowchart for explaining an example of operations performed during a device state list generation operation. The operations illustrated in the flowchart in FIG. 44 are performed by the state manager 18 in response to the reception of a device state list request from the request receiver 11.

Upon receiving the device state list request from the request receiver 11, firstly, the state manager 18 requests the user manager 12 for all mapping IDs corresponding to the user ID received along with the device state list request (Step S2101). Then, the state manager 18 obtains the mapping IDs that are sent in response to the request issued by the user manager 12 (Step S2102).

Subsequently, the state manager 18 requests the mapping manager 15 for all device IDs corresponding to the mapping IDs obtained at Step S2102 (Step S2103). Then, the state manager 18 obtains the device IDs that are sent in response to the request issued by the mapping manager 15 (Step S2104).

Subsequently, the state manager 18 collects the state information corresponding to the device IDs obtained at Step S2104, and sends the collected state information to the request receiver 11 (Step S2105). The state information collected by the state manager 18 is displayed in the device state list screen SC800 (see FIG. 23) in a viewable manner for the user.

Effect of First Embodiment

As described above in detail with reference to specific examples, in the device management system 1 according to the first embodiment, the device management apparatus 10 issues mapping IDs representing logical management identification information to be used in managing the devices 20 and associates the mapping IDs with the device IDs that enable identification of the individual devices 20. Moreover, as a result of the replacement of a device 20, when the old device is replaced with a new device that is identified as an identical device 20 due to the cognitive recognition of the user, the device management apparatus 10 modifies the device ID corresponding to the mapping ID from the device ID of the old device to the device ID of the new device. Thus, according to the first embodiment, the devices that are identified as identical devices due to the cognitive recognition of the user are treated as identical devices, thereby enabling achieving reduction in the time and efforts needed for the management purposes.

For example, when a device 20 is replaced, the relationship between the old device and the new device is understood based on the mapping IDs. Hence, the user can be enabled to continually use the setting information of the old device as the setting information of the new device without having to perform any particular operation.

Furthermore, even when a device 20 is replaced, since the association between the device ID of the old device and the service ID is continually used as the association between the device ID of the new device and the service ID by making use of the mapping ID and the user ID, the usage volume can be counted in a consistent manner in the old device and the new device.

Supplementary Explanation

The functional constituent elements of the device management apparatus 10 according to the first embodiment can be implemented, for example, as a result of cooperation between the hardware, which is in the form of the general-purpose computer illustrated in FIG. 2, and computer programs (software) executed using the hardware. In this case, for example, the computer programs used in implementing the functional constituent elements of the device management apparatus 10 can be stored in advance in the ROM 103 or the nonvolatile memory 104 in the device management apparatus 10. Alternatively, the computer programs can be recorded as installable or executable files in a computer-readable recording medium such as a compact disk read only memory (CD-ROM), a flexible disk (FD), a compact disk recordable (CD-R), or a digital versatile disk (DVD).

Still alternatively, the computer programs can be stored in some other computer connected to the network 40, and can be downloaded in the device management apparatus 10 via the network 40. Still alternatively, the computer programs can be distributed via the network 40.

The computer programs executed in the device management apparatus 10 contain modules including program components for the functional constituent elements of the device management apparatus 10 (i.e., the request receiver 11, the user manager 12, the service manager 13, the device availability manager 14, the mapping manager 15, the setting manager 16, the usage history manager 17, and the state manager 18). As far as the actual hardware is concerned, for example, the CPU 101 reads the computer programs from the ROM 103 or the nonvolatile memory 104 and executes them so that the functional constituent elements are loaded and generated in a main memory unit such as the RAM 102.

Meanwhile, in the case of implementing the device management apparatus 10 using a combination of a plurality of computers, each computer can be provided with a computer program corresponding to the functional constituent elements to be implemented in that computer. Furthermore, some or all of the functional constituent elements of the device management apparatus 10 can be implemented using dedicated hardware such as an application specific integrated circuit (ASIC) or a field-programmable gate array (FPGA).

### Second Embodiment

Given below is the explanation of a second embodiment. In the second embodiment, a specific method for obtaining the information managed by the device management apparatus 10 is explained, and a specific method for setting usage restrictions is explained. In the first embodiment, it is explained that the user of the device management system 1 can use the management terminal 30 and issue various requests to the device management apparatus 10. In the second embodiment, as a specific method by which the device management apparatus 10 receives a request for obtaining information or a request for setting usage restrictions, the WebAPI technology is implemented (WebAPI stands for Web Application Programming Interface). That is, in the second embodiment, the request receiver 11 of the device management apparatus 10 includes a WebAPI for receiving various requests issued thereto via the network 40.

In the second embodiment, for example, using the WebAPI provided in the device management apparatus 10, it is made possible to obtain counter information (various counter values) indicating the usage frequency of the devices 20 managed by the device management apparatus 10 and the usage frequency of device-linked services; and to obtain usage restriction information indicating the setting details of the usage restrictions (upper limit values for various counters) with respect to the devices 20 and the device-linked services. Moreover, in the second embodiment, using the WebAPI provided in the device management apparatus 10, it is made possible to arbitrarily set the usage restrictions with respect to the devices 20 and the device-linked services. Meanwhile, the information that can be obtained from the device management apparatus 10 using the WebAPI is not restricted to the counter information and the usage restriction information, and it is possible to obtain a variety of information managed by the device management apparatus 10. For example, in the first embodiment, the result of counting the usage volume of services and the list of states of the devices 20 are given as the examples of the information obtained by the user from the device management apparatus 10 using the management terminal 30. Such information can also be obtained using the WebAPI. Moreover, the setting performed using the WebAPI is not limited to the usage restrictions, and it is possible to perform various settings managed by the device management apparatus 10. For example, in the first embodiment, the explanation is given for a mechanism for enabling the user to perform the printer setting and the scanner setting in the devices 20 using the management terminal 30. Such settings in the devices 20 can also be performed using the WebAPI.

Given below is the explanation of the device-linked services considered in the second embodiment. A device-linked service is a service implemented as a result of cooperation between the device management apparatus 10, which is configured, for example, as a cloud server, and the devices 20. Examples of the device-linked service include a cloud scanning service and a cloud printing service. In the cloud scanning service, image data that is scanned in the device 20 and transferred to the cloud (the device management apparatus 10) is stored in a predetermined storage and is distributed to predetermined distribution destinations. In the cloud printing service, print data that has been uploaded in advance in the cloud (the device management apparatus 10) is downloaded in the device 20, and the device 20 is made to execute a printing job based on the print data. Herein, applications for implementing such device-linked services are installed in the device management apparatus 10, and the device-linked services are executed when the user makes use of the applications over the cloud.

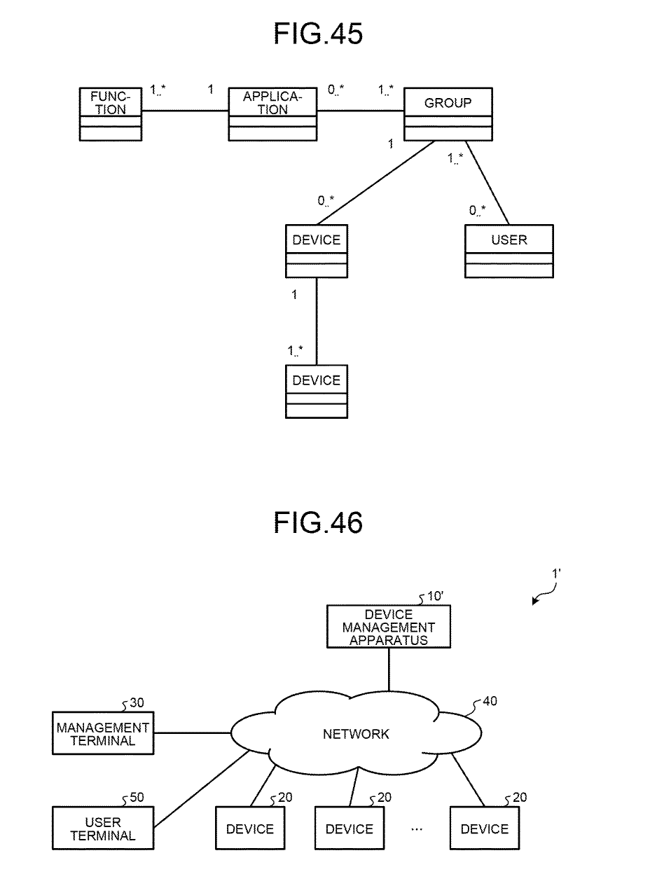

Meanwhile, in the second embodiment, it is assumed that the users of the device management system 1 form groups. For example, in an office environment, groups can be set according to the types of work assignment, such as the group of a particular section of a particular department. FIG. 45 is a diagram illustrating a data model in units for management assumed in the second embodiment, and a UML-based format (UML stands for Unified Modeling Language) is used to express a group and the relationship between the users, the applications, and the devices 20 belonging to that group. In FIG. 45, “application” represents an application meant for implementing a device-linked service, and “function” linked to “application” represents the functions (such as the cloud scanning service and the could printing service) implemented using “application”. Moreover, in FIG. 45, “device” represents the device 20 managed by the device management apparatus 10, and “function” linked to “device” represents the functions (mainly copying, printing, scanning, and FAX) provided in the device 20. In the second embodiment, as illustrated in FIG. 45, the users, the applications, and the functions are clubbed into one according to the concept of group. That is, the users, the applications, and the devices are associated via the group, and the users belonging to a group can make use of the applications, the devices, and the functions belonging to the same group.

In the second embodiment, as an example, the explanation is given for a mechanism in which an external device such as the management terminal 30 obtains counter information (1) to (3) given below from the device management apparatus 10, and applies usage restrictions of an arbitrary number.

(1) function-by-function (copying, printing, scanning, and FAX) counter value and user-by-user counter value for each device 20 belonging to a particular group

(2) total of function-by-function counter value and user-by-user counter value for the devices 20 belonging to a particular group

(3) function-by-function counter value and user-by-user counter value for each application belonging to a particular group

The counter information (1) represents information that the device management apparatus 10 collects from the devices 20 and stores/manages therein. The counter information (2) represents information that the device management apparatus 10 counts based on the counter information (1) and stores/manages therein. The counter information (3) represents information that the device management apparatus 10 counts according to the use of device-linked services and stores/manages therein. Since the use of device-linked services is counted in the devices 20 too, the counter information (1) contains counts overlapping with the counter information (3).

Given below is the explanation of a specific example of a configuration and operations of the device management system according to the second embodiment. In the second embodiment, the constituent elements identical to the constituent elements in the first embodiment are referred to by the same reference numerals; the constituent elements corresponding to the constituent elements in the first embodiment are referred to by the same reference numerals but with a prime mark ′; and the redundant explanation is not repeated.

FIG. 46 is a system configuration diagram illustrating an overview of a device management system 1′ according to the second embodiment. In the device management system 1′ according to the second embodiment, a user terminal 50, which is used by the user to access the applications in a device management apparatus 10′ for utilizing the device-linked services, is communicably connected to the device management apparatus 10′ via the network 40 along with the devices 20 and the management terminal 30. Examples of the user terminal 50 include information processing devices such as a PC installed with a web browser; a tablet terminal; and a smartphone.

In the second embodiment, in the case of using a device-linked service, the user accesses the device management apparatus 10′ using the user terminal 50, specifies the application to be used, and requests for execution reservation regarding the concerned device-linked service. In response to the user request, the device management apparatus 10′ performs execution reservation regarding the device-linked service based on the specified application; issues, for example, reservation information such as a pin code; and sends the reservation information to the user terminal 50 in response to the user request. Then, the user inputs the reservation information such as the pin code in the device 20 to be used for utilizing the device-linked service, and uses the application specified at the time of requesting for execution reservation. As a result, the cloud scanning service or the cloud printing service corresponding to the application is executed. At that time, the device management apparatus 10′ counts, as the usage history of the use of the application by the user, the job execution count of the device-linked service corresponding to the application; and stores the count value.

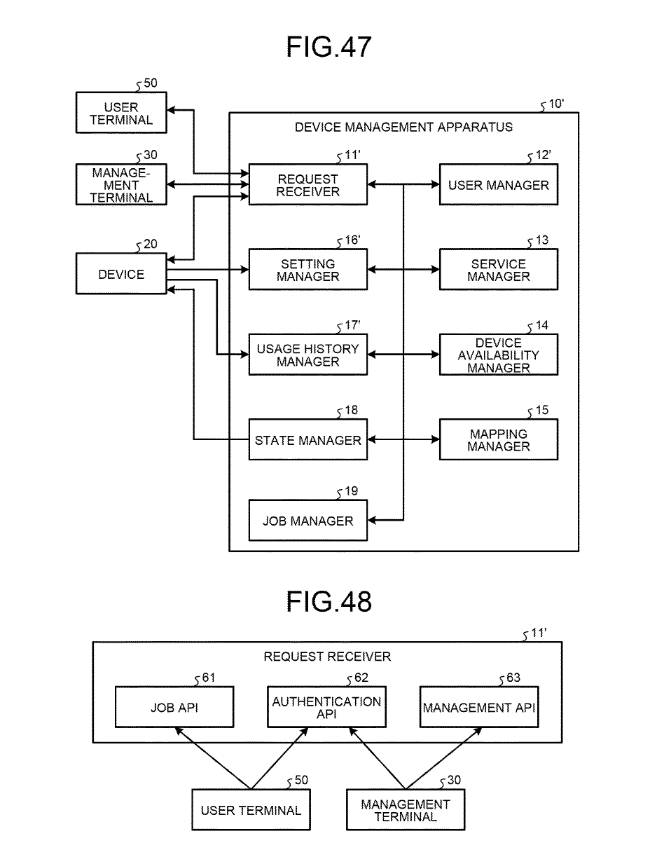

FIG. 47 is a block diagram illustrating an exemplary functional configuration of the device management apparatus 10′ according to the second embodiment. As the functional constituent elements implemented as a result of cooperation between the hardware and the software (computer programs) identical to the first embodiment; the device management apparatus 10′ includes, for example, a request receiver 11′, a user manager 12′, the service manager 13, the device availability manager 14, the mapping manager 15, a setting manager 16′, a usage history manager 17′, the state manager 18, and a job manager 19 as illustrated in FIG. 47. Of those constituent elements, the service manager 13, the device availability manager 14, the mapping manager 15, and the state manager 18 are identical to the first embodiment. Hence, their explanation is not repeated.

The request receiver 11′ has the functions of the request receiver 11 according to the first embodiment as well as has the function of receiving, via a WebAPI, various requests issued by the user to the device management apparatus 10′ using the management terminal 30 and the user terminal 50. In the second embodiment, as a result of having a WebAPI in the request receiver 11′, the functions of the device management apparatus 10′ are publicly disclosed over the network 40. When various requests are issued in the form of HTTP requests (HTTP stands for HyperText Transfer Protocol) to the device management apparatus 10′ from the management terminal 30 or the user terminal 50 via the network 40, the responses to the requests are sent in the form of HTTP responses from the device management apparatus 10′ to the management terminal 30 or the user terminal 50.

FIG. 48 is a diagram for explaining an overview of the request receiver 11′. For example, as illustrated in FIG. 48, the request receiver 11′ includes three types of WebAPIs, namely, a job API 61, an authentication API 62, and a management API 63. The job API 61 receives execution reservation for a device-linked service from the user terminal 50 and returns reservation information such as a pin code. The authentication API 62 receives a login request from the user terminal 50 or the management terminal 30, and returns an authentication result. The management API 63 receives, from the management terminal 30, a counter information obtaining request, a usage restriction information obtaining request, or a usage restriction setting request; and returns information in response to an information obtaining request or returns a notification of completion of the setting in response to a usage restriction setting request. Meanwhile, in the second embodiment, it is assumed that the management terminal 30 is installed with a web browser, and that information obtaining requests and usage restriction setting requests are issued from the management terminal 30 to the device management apparatus 10′. However, the various requests issued to the device management apparatus 10′ are not limited to be issued from the management terminal 30, and can be issued from various information processing devices installed with a web browser and connected to the network 40.

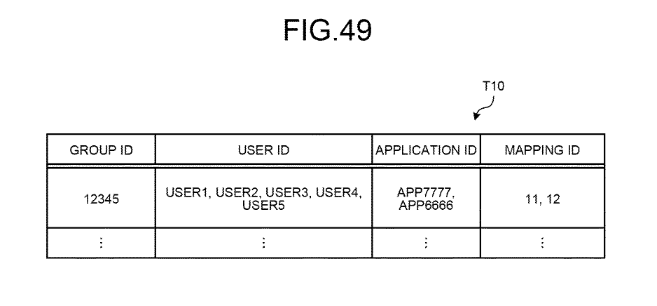

In an identical manner to the user manager 12 according to the first embodiment, the user manager 12′ has the function of storing/managing the user information using the user management table T1 illustrated in FIG. 6; as well as has the function of storing/managing group information related to the groups of users. FIG. 49 is a diagram illustrating an exemplary data structure of the group information stored by the user manager 12′. In the group information, the following information is stored in a corresponding manner: group IDs enabling identification of the groups; user IDs of the users belonging to each group: application IDs enabling identification of the device-linked services available for the users belonging to each group; and mapping IDs corresponding to the devices 20 usable by the users belonging to each group. For example, as illustrated in FIG. 49, the group information is registered and stored in a group management table T10 that is built in the nonvolatile memory 104.

Meanwhile, in the second embodiment, it is assumed that the user manager 12′ stores/manages the user information and the group information as separate information. However, alternatively, for example, by adding columns for storing group IDs and application IDs in the user management table T1 illustrated in FIG. 6, the user information and the group information can be stored/managed in an integrated manner.

In an identical manner to the usage history manager 17 according to the first embodiment, the usage history manager 17′ has the function of storing/managing the log information collected from the devices 20 as the history information; as well as has the function of storing/managing the counter information on a group-by-group basis. The group-by-group counter information contains the counter values of the counter information (1), the counter values of the counter information (2), and the counter values of the counter information (3).

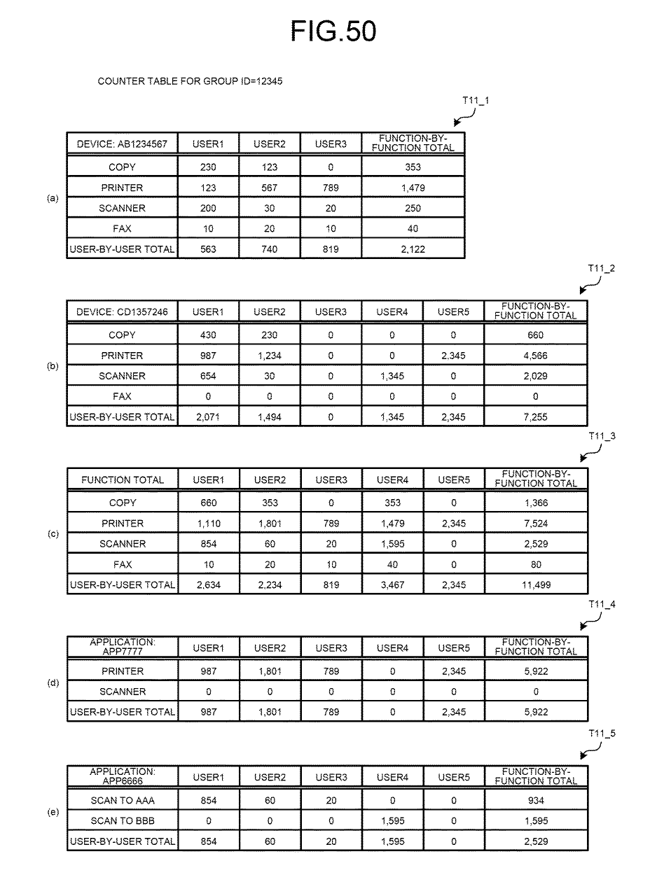

FIG. 50 is a diagram illustrating an exemplary data structure of the counter information, and an example of counter information related to a group having the group ID “12345” (see FIG. 49) is illustrated. For example, as illustrated in FIG. 50, the counter information is registered and stored in counter tables T11_1 to T11_5 that are built in the nonvolatile memory 104 in units of groups.

The counter table T11_1 illustrated in FIG. 50(a) as well as the counter table T11_2 illustrated in FIG. 50(b) represents the counter values for a particular device 20 belonging to the group having the group ID “12345”. That is, the counter table T11_1 illustrated in FIG. 50(a) represents the counter values for the device 20 corresponding to the mapping ID “11” illustrated in FIG. 49 (i.e., the device 20 having the device ID “AB123456”). The counter table T11_2 illustrated in FIG. 50(b) represents the counter values for the device 20 corresponding to the mapping ID “12” illustrated in FIG. 49 (i.e., the device 20 having the device ID “CD1357246”). Herein, the device-by-device counter values for the devices 20 as specified in the counter tables are equivalent to the counter information (1).

In the second embodiment, each device 20 that is managed by the device management apparatus 10′ is assumed to count up the job execution counts as the usage history of the user of the device 20 by the user, and to store the usage history as the function-by-function counter values and the user-by-user counter values. Then, each device 20 sends the counter values stored therein to the device management apparatus 10′ at predetermined timings. The usage history manager 17′ in the device management apparatus 10′ registers the counter values, which are sent by each device 20 at predetermined timings, in the device-by-device counter tables for the devices 20 as illustrated in FIGS. 50(a) and 50(b). Regarding the user-by-user total counter value or the function-by-function total counter value, the counter values either can be values counted by the devices 20 or can be values counted by the usage history manager 17′ in the device management apparatus 10′. Moreover, regarding the timing at which each device 20 sends the counter values to the device management apparatus 10′; either the counter values can be sent every time a job is executed in an identical manner to the manner of sending log information according to the first embodiment, or the counter values can be sent at the time of activation of the device 20 and then periodically sent at regular intervals after the activation of the device 20, or the counter values can be sent by combining the two methods. Meanwhile, as far as identification of the user in the device 20 is concerned, for example, the user can be asked to perform a login operation using the operation panel of the device 20 at the time of executing a job.

The counter table T11_3 illustrated in FIG. 50(c) represents the total counter values of the devices 20 belonging to the group having the group ID “12345”. The counter values in the counter table T11_3 are counted by the usage history manager 17′ based on the counter values in the counter table T11_1 illustrated in FIG. 50(a) and the counter values in the counter table T11_2 illustrated in FIG. 50(b). Herein, the counter values in the counter table T11_3 are equivalent to the counter information (2).

The counter table T11_4 illustrated in FIG. 50(d) as well as the counter table T11_5 illustrated in FIG. 50(e) represents the counter values for a particular application belonging to the group having the group ID “12345”. That is, the counter table T11_4 illustrated in FIG. 50(d) represents the counter values indicating the usage history of the application having the application ID “APP7777” (see FIG. 49). The counter table T11_5 illustrated in FIG. 50(e) represents the counter values indicating the usage history of the application having the application ID “APP6666” (see FIG. 49). The application-by-application counter values specified in these counter tables are equivalent to the counter information (3).

When the request receiver 11′ receives a counter information obtaining request from the management terminal 30, the usage history manager 17′ reads the counter information corresponding to the group specified in that obtaining request from the nonvolatile memory 104 and sends the counter information to the request receiver 11′. Then, in response to the obtaining request issued by the management terminal 30, the request receiver 11′ sends the counter information corresponding to the specified group to the management terminal 30.

The setting manager 16′ has the function of storing/managing the setting information, such as the printer settings and the scanner settings, of each device 20 in an identical manner to the setting manager 16 according to the first embodiment; as well as has the function of storing/managing the group-by-group usage restriction information. Herein, the group-by-group usage restriction information contains the upper limit value set with respect to each counter in the counter information (1), the upper limit value set with respect to each counter in the counter information (2), and the upper limit value set with respect to each counter in the counter information (3).

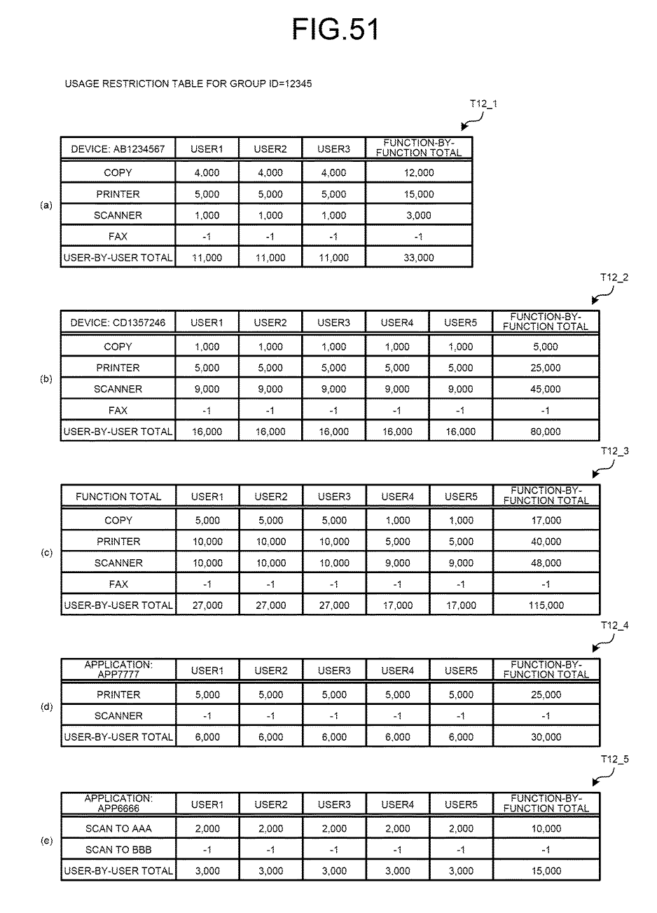

FIG. 51 is a diagram illustrating an exemplary data structure of the usage restriction information, and represents the setting details of the usage restrictions (the upper limit values of counters) set with respect to the counters in the counter information illustrated in FIG. 50. In FIG. 51, the numerical values indicate the upper limit values, and “−1” indicates that no usage restriction is set. For example, as illustrated in FIG. 51, the usage restriction information is registered and stored in usage restriction tables T12_1 to T12_5 that are built in the nonvolatile memory 104 in units of groups.

The usage restriction table T12_1 illustrated in FIG. 51(a) represents an example of the usage restriction information corresponding to the counter table T11_1 illustrated in FIG. 50(a) and includes the details of the usage restriction set with respect to the device 20 having the device ID “AB123456”. The usage restriction table T12_2 illustrated in FIG. 51(b) represents an example of the usage restriction information corresponding to the counter table T11_2 illustrated in FIG. 50(b) and includes the details of the usage restriction set with respect to the device 20 having the device ID “CD1357246”. The usage restriction information set in each such device 20 is reflected therein as a result of the setting synchronization operation performed between the setting manager 16′ and the concerned device 20.

The usage restriction table T12_3 illustrated in FIG. 51(c) represents an example of the usage restriction information corresponding to the counter table T11_3 illustrated in FIG. 50(c) and includes the details of the overall usage restrictions set with respect to the devices 20 belonging to the group having the group ID “12345”. The usage restriction table T12_4 illustrated in FIG. 51(d) represents an example of the usage restriction information corresponding to the counter table T11_4 illustrated in FIG. 50(d) and includes the details of the usage restrictions set with respect to the application having the application ID “APP7777”. The usage restriction table T12_5 illustrated in FIG. 51(e) represents an example of the usage restriction information corresponding to the counter table T11_5 illustrated in FIG. 50(e) and includes the details of the usage restrictions set with respect to the application having the application ID “APP6666”.

The usage restrictions with respect to the device 20 and the device-linked services can be applied based on the counter information stored/managed by the usage history manager 17′ and based on the usage restriction information stored/managed by the setting manager 16′. That is, the utilizable count is calculated as needed from various current counter values and the respective upper limit values, and the use of the devices 20 and the device-linked services is restricted in such a way that the counter values do not exceed the respective upper limit values.

In the second embodiment, as illustrated in the usage restriction tables T12_1 to T12_5, it is made possible to set the function-by-function usage restrictions and the user-by-user usage restrictions with respect to each device 20 belonging to a particular group, with respect to the total number of devices 20, and with respect to each application. Moreover, it is also made possible to set the total user-by-user usage restrictions and the total function-by-function usage restrictions. As a result of setting the total user-by-user usage restrictions, it becomes possible to restrict the total usage volume of the devices 20 and the applications by a particular user. As a result of setting the total function-by-function usage restrictions, it becomes possible to restrict the total usage volume of the functions of a particular device 20 or the functions of a particular application. For example, in the usage restriction table T12_1 illustrated in FIG. 51(a), although no usage restrictions are set with respect to the “FAX” function, the upper limit value of the counters for the total user-by-user usage restrictions is set to “11,000” with respect to each user from a “user 1” to a “user 3”. Accordingly, the use of the “FAX” function gets restricted in such a way that the total number of counters of other functions does not exceed “11,000”.

When the request receiver 11′ receives, from the management terminal 30, an obtaining request for obtaining usage restriction information; the setting manager 16′ reads the usage restriction information corresponding to the group specified in the obtaining request from the nonvolatile memory 104 and sends the usage restriction information to the request receiver 11′. Thus, in response to the obtaining request issued by the management terminal 30, the request receiver 11′ can send the usage restriction information corresponding to the specified group to the management terminal 30.

Moreover, when the request receiver 11′ receives a usage restriction setting request from the management terminal 30, the setting manager 16′ modifies the usage restriction settings of the group specified in that setting request as well as modifies the target category for setting (one of (1) to (3) described earlier) according to the setting request, and updates the usage restriction information stored as a usage restriction table in, for example, the nonvolatile memory 104. Once the modification of usage restriction settings is completed, the setting manager 16′ notifies the request receiver 11′ about the completion of the setting modification. As a result, in response to the usage restriction setting request received from the management terminal 30, the request receiver 11′ can send a setting completion notification to the management terminal 30 indicating the completion of the setting of the usage restrictions corresponding to the specified target category for setting.

The job manager 19 represents a functional module that manages the execution of jobs which are based on the device-linked services. When the request receiver 11′ receives a request for execution reservation of a device-linked service from the user terminal 50, the job manager 19 issues reservation information such as a pin code and sends the reservation information to the request receiver 11′. Thus, in response to the request issued by the user terminal 50, the request receiver 11′ can send the reservation information such as a pin code to the user terminal 50.

Moreover, when reservation information such as a pin code that is input by the user in the device 20 is received, the job manager 19 calls the application identified by the reservation information and controls the execution of the job based on the cloud scanning service or the cloud printing service in accordance with the identified application. At that time, the job manager 19 counts up the job execution count of the device-linked service corresponding to the application, and notifies the usage history manager 17′ about the job execution count. That enables the usage history manager 17′ to store/manage the application-by-application count information.

As described above, in the device management apparatus 10′ according to the second embodiment, the request receiver 11′ has a WebAPI that is used to receive various requests issued to the device management apparatus 10′. Thus, information from the device management apparatus 10′ can be obtained and various settings can be done using an arbitrary management tool. In the following explanation, it is assumed that the management terminal 30 is equipped with a management tool for the purpose of obtaining counter information or usage restriction information and for the purpose of setting usage restrictions, and a specific example of the operations performed by the device management apparatus 10′ according to the second embodiment is explained under the premise that the user uses the management tool installed in the management terminal 30.

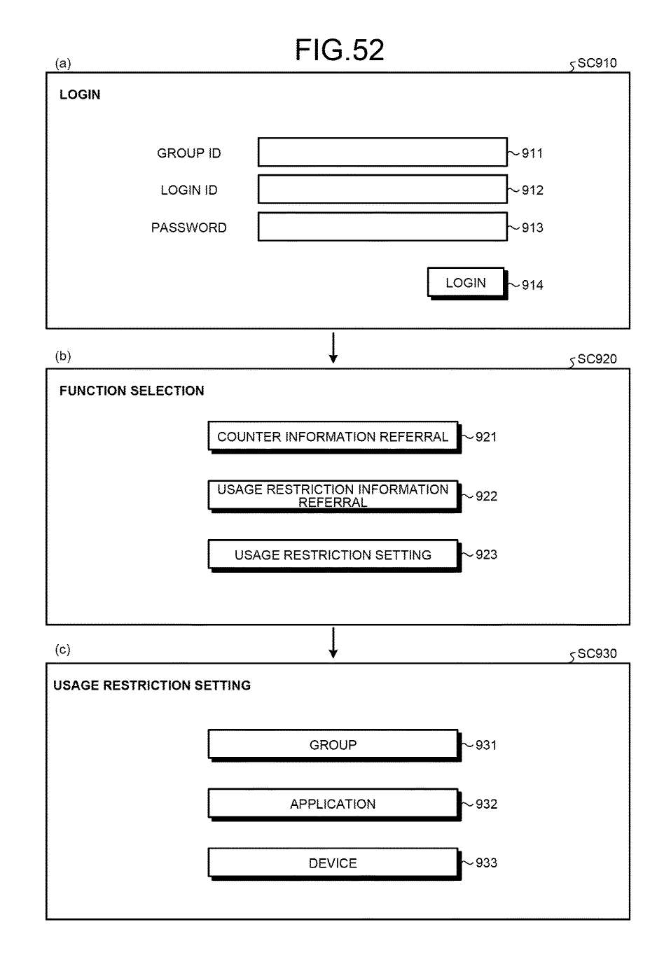

FIG. 52 is a diagram illustrating exemplary screens of the management tool that are displayed on the display panel 307 of the management terminal 30, and illustrating an example of screen transition in the case of setting usage restrictions. The screen illustrated in FIG. 52(a) represents an example of a login screen SC910 that is initially displayed on the display panel 307 of the management terminal 30. In the login screen SC910, when the user inputs a group ID in a textbox 911, inputs a login ID in a textbox 912, inputs a password in a textbox 913, and presses a “login” button 914; the screen of the management tool undergoes a transition from the login screen SC910 illustrated in FIG. 52(a) to a function selection screen SC920 illustrated in FIG. 52(b).

The function selection screen SC920 illustrated in FIG. 52(b) includes a “counter information referral” button 921, a “usage restriction information referral” button 922, and a “usage restriction setting” button 923. The user can selectively press one of these buttons and request for obtaining the counter information or the usage restriction information or request for setting the usage restrictions. Herein, it is assumed that the user presses the “usage restriction setting” button 923 with the aim of setting usage restrictions. When the user presses the “usage restriction setting” button 923 in the selection function screen SC920, the screen of the management tool undergoes a transition from the function selection screen SC920 illustrated in FIG. 52(b) to a usage restriction setting screen SC930 illustrated in FIG. 52(c).

The usage restriction setting screen SC930 illustrated in FIG. 52(c) includes a “group” button 931, an “application” button 932, and a “device” button 933. The user can selectively press one of these buttons and specify the target category for setting. Herein, the target category for setting represents the category with respect to which the usage restrictions are to be set; and indicates whether the usage restrictions for each device 20 in the group are to be set, or whether the overall usage restrictions for the devices 20 in the group are to be set, or whether the usage restrictions for each application in the group are to be set. When the user specifies the target category for setting in the usage restriction setting screen SC930, the management terminal 30 can request the device management apparatus 10′ to obtain the usage restriction information having the group (the group ID input in the login screen SC910) and the target category for setting specified therein; and can obtain the usage restriction information of the specified group and the target category for setting from the device management apparatus 10′.

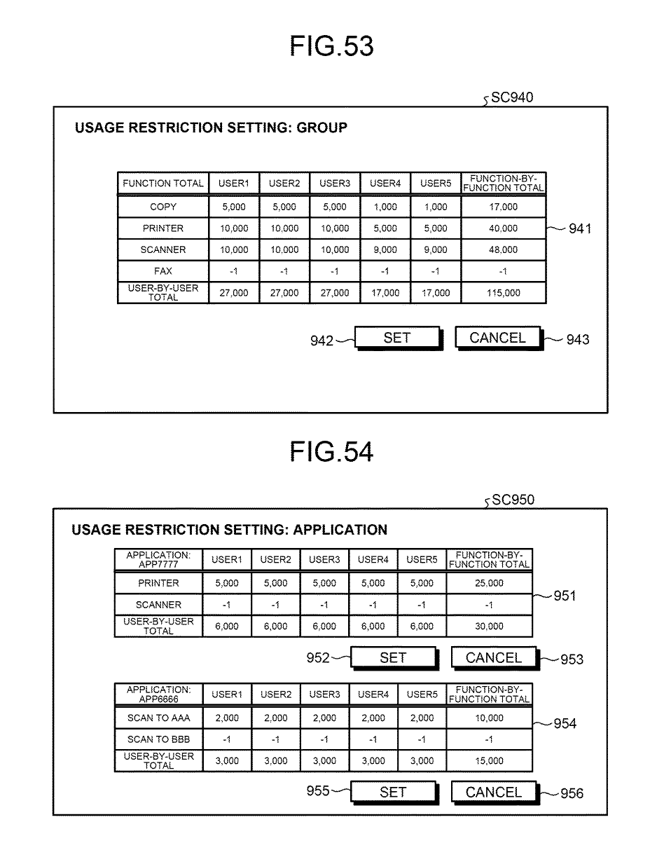

FIG. 53 is a diagram illustrating an example of a setting input screen SC940 that is displayed when the user presses the “group” button 931 in the usage restriction setting screen C930 illustrated in FIG. 52(c). The setting input screen SC940 includes a display area 941 for displaying in a rewritable manner the usage restriction information (corresponding to the usage restriction table T12_3 illustrated in FIG. 52(c)) that indicates the details of the overall current usage restrictions for the devices 20 in the specified group; includes a “set” button 942; and includes a “cancel” button 943. When the user rewrites the numerical values displayed in the display area 941 in the setting input screen SC940 to desired numerical values and presses the “set” button 942; a request for setting the usage restrictions is issued from the management terminal 30 to the device management apparatus 10′, and the overall usage restrictions with respect to the devices 20 in the group are newly set according to the details input by the user. Meanwhile, when the user presses the “cancel” button 943 in the setting input screen SC940, the operations are terminated and, for example, the screen of the management tool returns to the function selection screen SC920 illustrated in FIG. 52(b).

FIG. 54 is a diagram illustrating an example of a setting input screen SC950 that is displayed when the user presses the “application” button 932 in the usage restriction setting screen SC930 illustrated in FIG. 52(c). The setting input screen SC950 includes the following: display areas 951 and 954 for displaying in a rewritable manner the usage restriction information (corresponding to the usage restriction table T12_4 illustrated in FIG. 51(d) and the usage restriction table T12_5 illustrated in FIG. 51(e)) that indicates the details of the current usage restrictions for each application in the specified group; “set” buttons 952 and 955; and “cancel” buttons 953 and 956. When the user rewrites the numerical value displayed in the display area 951 or the display area 954 in the setting input screen SC945 to a desired numerical value and presses the “set” button 952 or the “set” button 955; a request for setting the usage restrictions is issued from the management terminal 30 to the device management apparatus 10′, and the usage restrictions for each application in the group are newly set according to the details input by the user. Meanwhile, when the user presses the “cancel” button 953 or the “cancel” button 956 in the setting input screen SC950, the operations are terminated and, for example, the screen of the management tool returns to the function selection screen SC920 illustrated in FIG. 52(b).

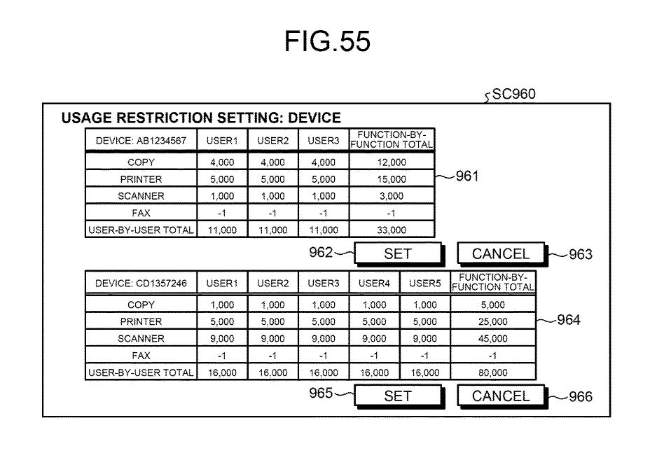

FIG. 55 is a diagram illustrating an example of a setting input screen SC960 that is displayed when the user presses the “device” button 933 in the usage restriction setting screen SC930 illustrated in FIG. 52(c). The setting input screen SC960 includes the following: display areas 961 and 964 for displaying in a rewritable manner the usage restriction information (corresponding to the usage restriction table T12_1 illustrated in FIG. 51(a) and the usage restriction table T12_2 illustrated in FIG. 51(b)) that indicates the details of the current usage restrictions for each device 20 in the specified group; “set” buttons 962 and 965; and “cancel” buttons 963 and 966. When the user rewrites the numerical value displayed in the display area 961 or the display area 964 in the setting input screen SC945 to a desired numerical value and presses the “set” button 962 or the “set” button 965; a request for setting the usage restrictions is issued from the management terminal 30 to the device management apparatus 10′, and the usage restrictions for each device 20 in the group are newly set according to the details input by the user. Meanwhile, when the user presses the “cancel” button 963 or the “cancel” button 966 in the setting input screen SC950, the operations are terminated and, for example, the screen of the management tool returns to the function selection screen SC920 illustrated in FIG. 52(b).

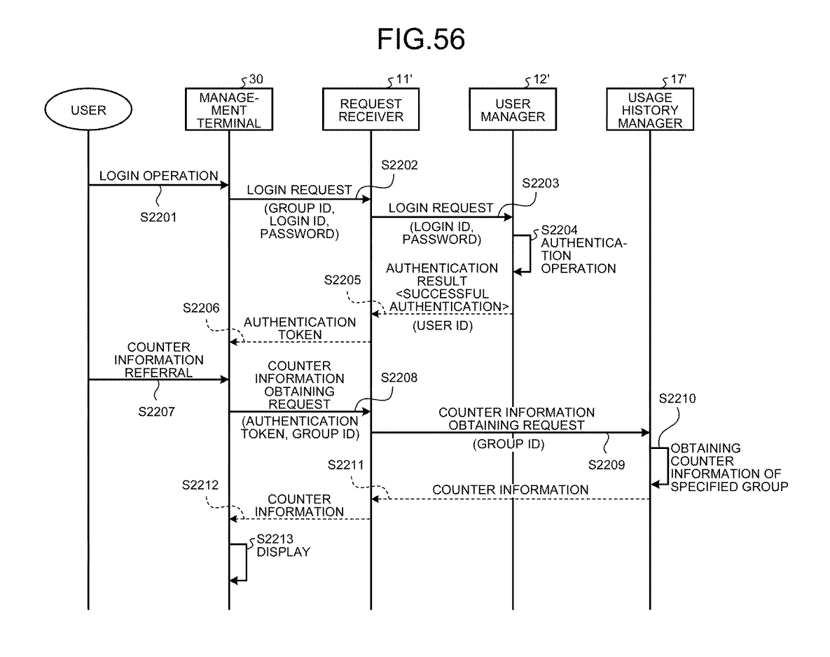

FIG. 56 is a sequence diagram for explaining an example of operations performed in response to a counter information obtaining request. Firstly, when the user performs a login operation from the login screen SC910 of the management tool (Step S2201), a login request is issued from the management terminal 30 to the device management apparatus 10′, and the login request is received by the request receiver 11′ (Step S2202). The login request is attached with the group ID, the login ID, and the password input by the user. Upon receiving the login request, the request receiver 11′ sends it to the user manager 12′ (Step S2203).

Upon receiving the login request from the request receiver 11′, the user manager 12′ performs an authentication operation with respect to the user based on the login ID and the password attached to the login request (Step S2204). Then, the user manager 12′ sends the authentication result to the request receiver 11′ (Step S2205). Herein, it is assumed that the authentication result indicates successful authentication. The authentication result indicating successful authentication is attached with the user ID of the user whose authentication is successful. Upon receiving the authentication result indicating successful authentication from the user manager 12′, the request receiver 11′ sends an authentication token to the management terminal 30 (Step S2206).

When the user presses the “counter information referral” button 921 in the function selection screen SC920 of the management tool (Step S2207), a counter information obtaining request is issued from the management terminal 30 to the device management apparatus 10′, and the counter information obtaining request is received by the request receiver 11′ (Step S2208). The counter information obtaining request is attached with the authentication token and, for example, the group ID input by the user at the time of performing the login operation. Upon receiving the counter information obtaining request, the request receiver 11′ sends it to the usage history manager 17′ (Step S2209).

Upon receiving the counter information obtaining request from the request receiver 11′, the usage history manager 17′ obtains the counter information of the specified group based on the group ID attached to the counter information obtaining request (Step S2210) and sends the obtained counter information to the request receiver 11′ (Step S2211). Upon receiving the counter information from the usage history manager 17, the request receiver 11′ sends the counter information to the management terminal 30 in response to the counter information obtaining request (Step S2212). Then, the management terminal 30 displays the counter information that is received from the request receiver 11′ in response to the counter information obtaining request (Step S2213). That enables the user to refer to the counter information of the group identified by the group ID that was input at the time of performing the login operation, for example.

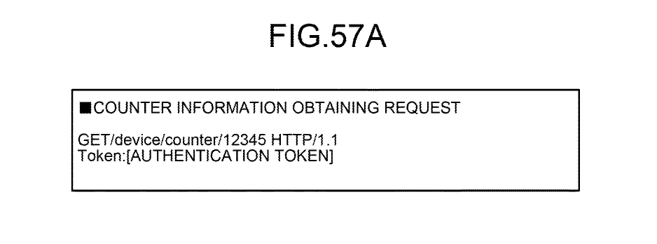

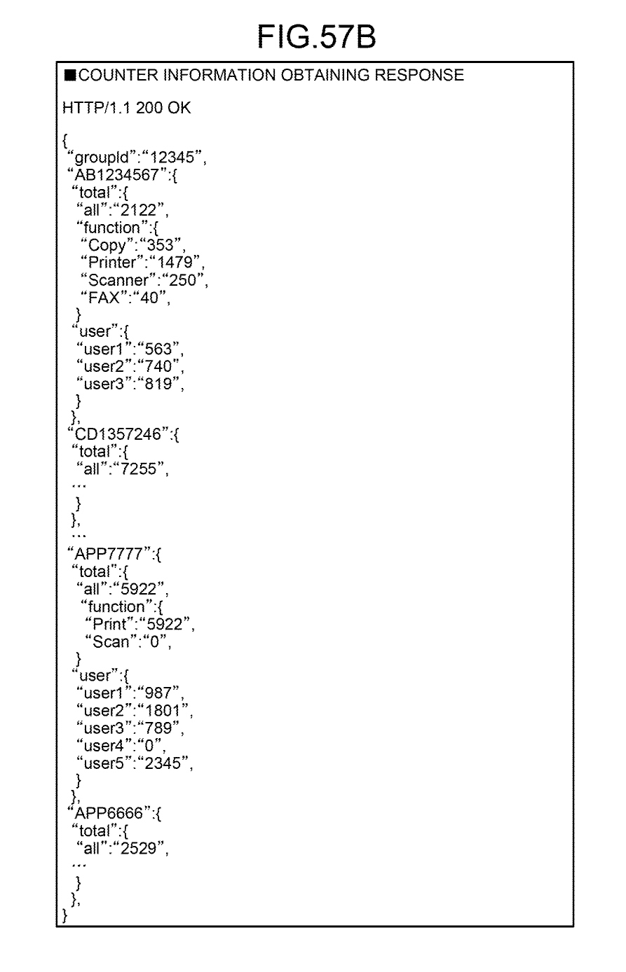

FIG. 57A is a diagram illustrating an example of data of a counter information obtaining request issued from the management terminal 30 to the device management apparatus 10′. FIG. 57B is a diagram illustrating an example of data of the response to the counter information obtaining request illustrated in FIG. 57A. The management terminal 30 issues a counter information obtaining request to the device management apparatus 10′ in the form of, for example, an HTTP request illustrated in FIG. 57A. In response, the management terminal 30 can receive counter information written in the form of, for example, an HTTP response illustrated in FIG. 57B. Meanwhile, in FIG. 57B, “ . . . ” indicates that some of the description is not illustrated.

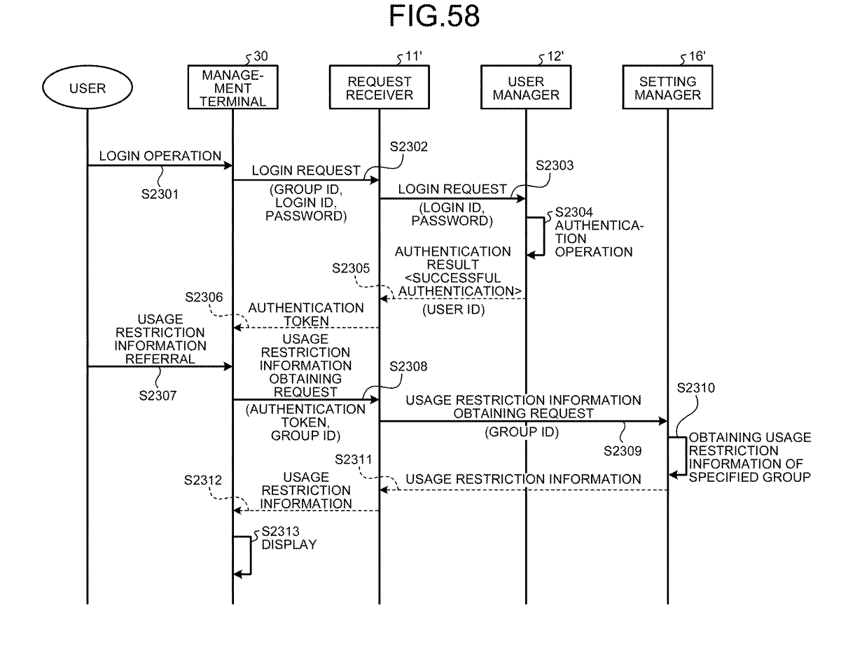

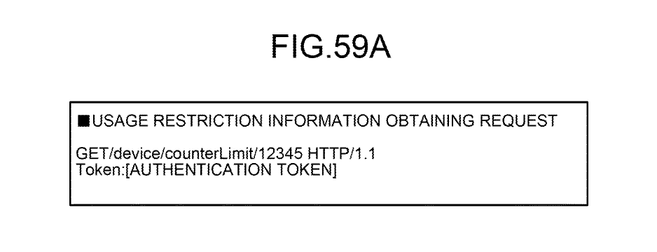

FIG. 58 is a sequence for explaining an example of operations performed in response to a usage restriction information obtaining request. Herein, the operations from Steps S2301 to S2306 illustrated in FIG. 58 (i.e., the authentication operation performed in response to the login operation) are identical to Steps S2201 to S2206 illustrated in FIG. 56. Hence, the explanation of those operations is not repeated.

After the authentication operation in response to the login operation is completed, when the user presses the “usage restriction information referral” button 922 in the function selection screen SC920 of the management tool (Step S2307), a usage restriction information obtaining request is issued from the management terminal 30 to the device management apparatus 10′, and the usage restriction information obtaining request is received by the request receiver 11′ (Step S2308). The usage restriction information obtaining request is attached with the authentication token and, for example, the group ID input by the user at the time of performing the login operation. Upon receiving the usage restriction information obtaining request, the request receiver 11′ sends it to the setting manager 16′ (Step S2309).

Upon receiving the usage restriction information obtaining request from the request receiver 11′, the setting manager 16′ obtains the usage restriction information of the specified group (Step S2310) and sends it to the request receiver 11′ (Step S2311). Upon receiving the usage restriction information from the setting manager 16′, the request receiver 11′ sends the usage restriction information to the management terminal 30 as the response to the usage restriction information obtaining request (Step S2312). Then, the management terminal 30 displays the usage restriction information that is received from the request receiver 11′ as the response to the usage restriction information obtaining request (Step S2313). That enables the user to refer to the usage restriction information indicating the details of usage restrictions that are currently set with respect to the group identified by the group ID which was input at the time of performing the login operation, for example.

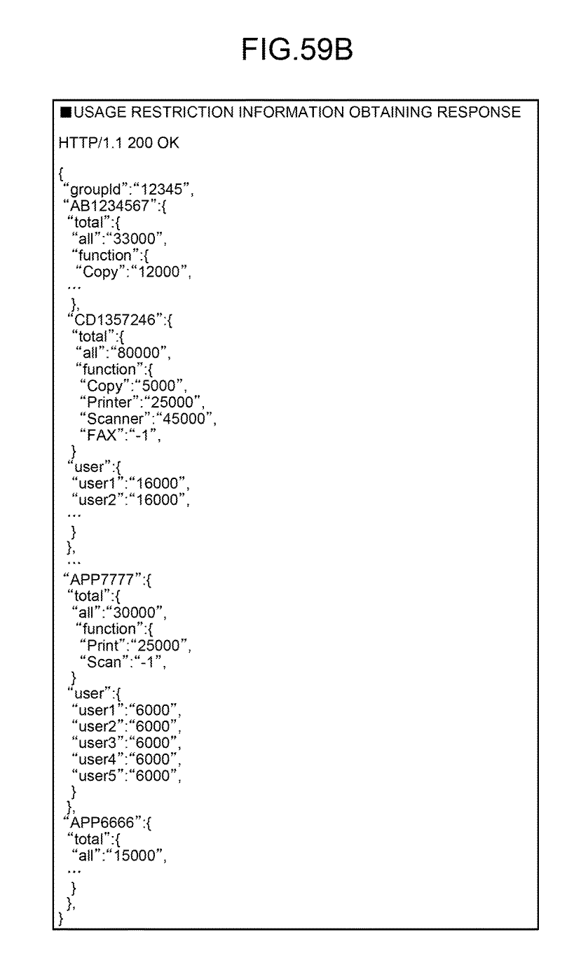

FIG. 59A is a diagram illustrating an example of data of a usage restriction information obtaining request issued from the management terminal 30 to the device management apparatus 10′. FIG. 59B is a diagram illustrating an example of data of the response to the usage restriction information obtaining request illustrated in FIG. 59A. The management terminal 30 issues a usage restriction information obtaining request to the device management apparatus 10′ in the form of, for example, an HTTP request illustrated in FIG. 59A. In response, the management terminal 30 can receive usage restriction information written in the form of, for example, an HTTP response illustrated in FIG. 59B. Meanwhile, in FIG. 59B, “ . . . ” indicates that some of the description is not illustrated.

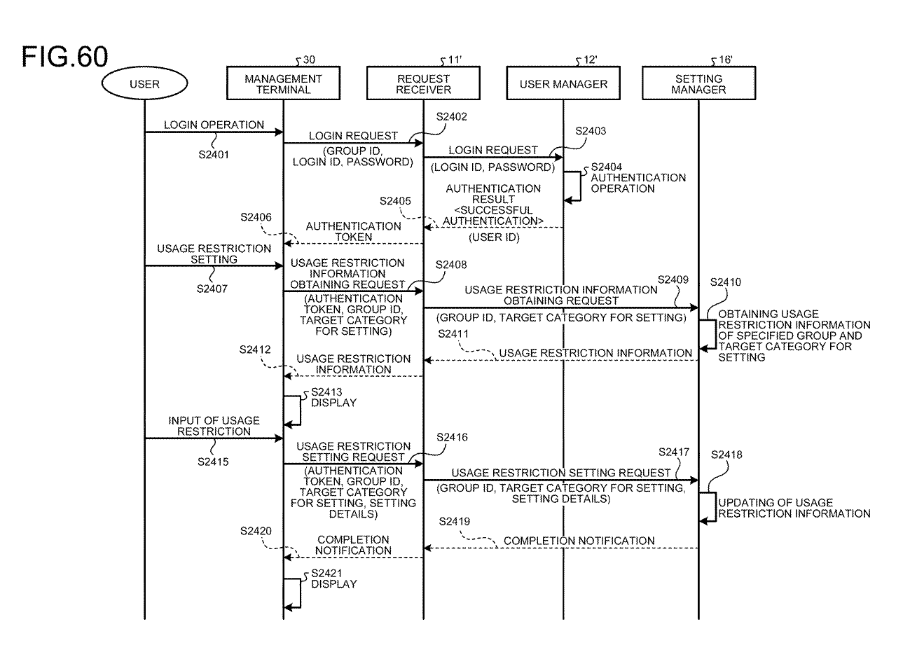

FIG. 60 is a sequence diagram for explaining an example of operations performed in response to a usage restriction setting request. The operations from Steps S2401 to S2406 illustrated in FIG. 60 (i.e., the authentication operation performed in response to the login operation) are identical to Steps S2201 to S2206 illustrated in FIG. 56 and identical Steps S2301 to S2306 illustrated in FIG. 58. Hence, the explanation of those operations is not repeated.

After the authentication operation in response to the login operation is completed, when the user presses the “usage restriction setting” button 923 in the function selection screen SC920 of the management tool (Step S2407); firstly, in order to display the current usage restriction information of the specified target category for setting on the management terminal 30, a usage restriction information obtaining request is issued from the management terminal 30 to the device management apparatus 10′; and the usage restriction information obtaining request is received by the request receiver 11′ (Step S2408). The usage restriction information obtaining request is attached with the authentication token, the group ID, and the target category for setting. Upon receiving the usage restriction information obtaining request, the request receiver 11′ sends it to the usage setting manager 16′ (Step S2409).

Upon receiving the usage restriction information obtaining request from the request receiver 11′, the setting manager 16′ obtains the usage restriction information of the specified group and the target category for setting based on the group ID and the target category for setting attached with the usage restriction information (Step S2410), and sends the usage restriction information to the request receiver 11′ (Step S2411). Upon receiving the usage restriction information from the setting manager 16′, the request receiver 11′ sends it to the management terminal 30 as the response to the usage restriction information obtaining request (Step S2412). Then, the management terminal 30 displays, in a rewritable manner on the setting input screen of the management tool (i.e., on either one of the setting input screen SC940 illustrated in FIG. 53, the setting input screen SC950 illustrated in FIG. 54, and the setting input screen SC960 illustrated in FIG. 55), the usage restriction information that is received from the request receiver 11′ as the response to the usage restriction information obtaining request (Step S2413).

Subsequently, when the user performs an input for the purpose of setting the usage restrictions in the setting input screen of the management tool (Step S2415), a usage restriction setting request is issued from the management terminal 30 to the device management apparatus 10′, and the usage restriction setting request is received by the request receiver 11′ (Step S2416). The usage restriction setting request is attached with the authentication token, the group ID, the target category for setting, and the setting details input by the user. Upon receiving the usage restriction setting request, the request receiver 11′ sends it to the setting manager 16′ (Step S2417). Upon receiving the usage restriction setting request from the request receiver 11′, the setting manager 16′ identifies the specified group and the target category for setting based on the group ID and the target category for setting attached to the usage restriction setting request, and updates the usage restriction information of the identified group and the identified target group for setting according to the setting details attached to the usage restriction setting request (Step S2418). When the updating of the usage restriction information is completed, that is, when new usage restrictions are set according to the setting input of the user; the setting manager 16′ notifies the request receiver 11′ about the completion of the setting (Step S2419). Upon receiving the notification about the completion of the setting of the usage restrictions from the setting manager 16′, the request receiver 11′ notifies the management terminal 30 about the completion of the setting as the response to the usage restriction setting request (Step S2420). Upon receiving the notification about the completion of the setting, the management terminal 30 displays, for example, a message indicating that the setting according to the input is completed (Step S2421).

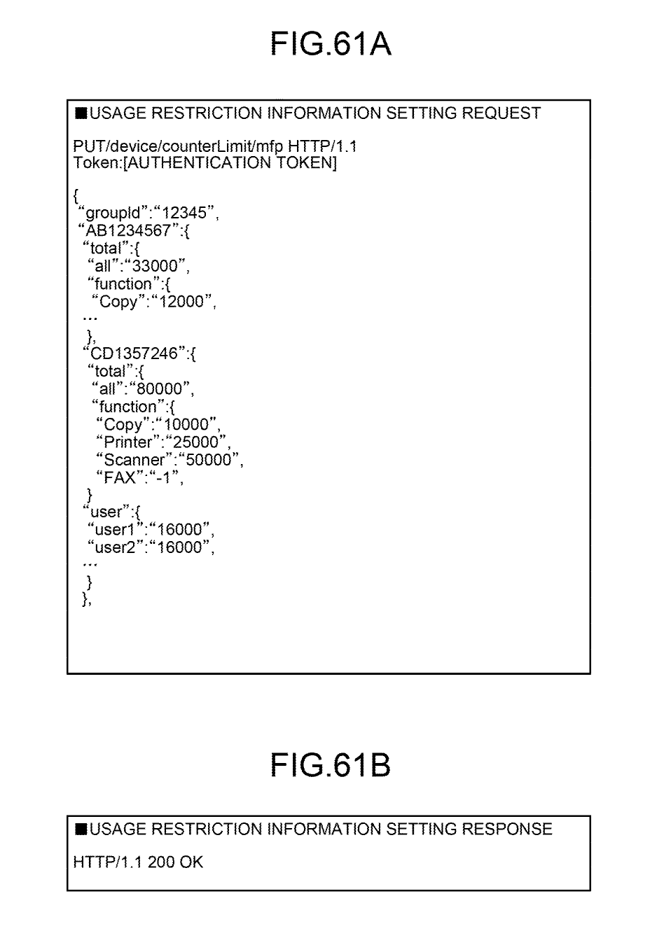

FIG. 61A is a diagram illustrating an example of data of a usage restriction setting request. FIG. 61B is a diagram illustrating an example of data of the response to the usage restriction setting request. The management terminal 30 can issue a usage restriction setting request to the device management apparatus 10′ in the form of, for example, an HTTP request illustrated in FIG. 61A and instruct the device management apparatus 10′ to set usage restrictions. When the setting of usage restrictions is completed, the management terminal 30 can receive a completion notification written in the form of, for example, an HTTP response illustrated in FIG. 61B. Meanwhile, in FIG. 61A is illustrated an example of a usage restriction setting request that is issued when “device” is selected indicating the setting of usage restrictions with respect to each device 20 as the target category for setting. Moreover, in FIG. 61A, “ . . . ” indicates that some of the description is not illustrated.

As described above in detail with reference to specific examples, in the device management apparatus 10′ according to the second embodiment, the request receiver 11′ has a WebAPI that is used in receiving various requests issued to the device management apparatus 10′. Therefore, a variety of information from the device management apparatus 10′ can be obtained and various settings can be performed using an arbitrary management tool, thereby easily enabling independent development of the management function on the outside of the device management apparatus 10′.

According to the present invention, the devices that are identified as identical devices due to the cognitive recognition are treated as identical devices, thereby enabling achieving reduction in the time and efforts needed for the management purposes.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A device management apparatus comprising processing circuitry configured to
issue management identification information for managing a device;
generate mapping information in which the management identification information is associated with device identification information for identifying the individual device; and
generate availability management information in which the device identification information is associated with availability indicating whether the device is available or unavailable, wherein
the processing circuitry generates the mapping information in which the management identification information associated with the device identification information of a first device is associated with the device identification information of a second device to be identified as the first device when generating, in response to a replacement request to replace the first device with the second device, the availability management information indicating that the first device is unavailable and the availability management information indicating that the second device is available.

2. The device management apparatus according to claim 1, wherein the processing circuitry
generates, as available mapping information, the mapping information that contains first time information which indicates time at which the device identification information is associated with the management identification information but that does not contain second time information which indicates time at which association of the device identification information with the management identification information is cancelled, and
generates, as unavailable mapping information, the mapping information that contains the first time information and the second time information.

3. The device management apparatus according to claim 2, wherein
the processing circuitry
stores setting information related to settings of the device and the device identification information in association with each other,
sends, in response to receiving a request to obtain the setting information for first device identification information from a device as a requestor, the setting information associated with the first device identification information to the requestor device,
issues, when the setting information associated with the first device identification information is not stored therein, a request to obtain second device identification information whose association with the management identification information associated with the first device identification information has been cancelled,
searches for, in response to the request to obtain the second device identification, unavailable mapping information to obtain the second device identification,
associates the setting information that is associated with the second device identification information obtained, with the first device identification information, and
sends the setting information associated with the first device identification information to the requestor device.

4. The device management apparatus according to claim 3, wherein
the processing circuitry
stores, for each group of users, usage restriction information indicating details of usage restrictions set with respect to devices and with respect to applications that use devices, and
sends, in response to a request to obtain the usage restriction information for a group, the usage restriction information for the group to a device as a requestor.

5. The device management apparatus according to claim 4, wherein the processing circuitry updates, in response to a request to set usage restrictions for a group, the usage restriction information for the group according to setting details.

6. The device management apparatus according to claim 1, wherein
the processing circuitry
stores user information in which user identification information for identifying a user is associated with one or more sets of the management identification information,
issues service identification information for identifying a service to be provided to a user according to service purchase by the user,
generates service management information in which the user identification information is associated with the service identification information, and
stores history information in which log information related to usage volume collected from a device is associated with the service identification information.

7. The device management apparatus according to claim 6, wherein
the processing circuitry
issues a request to obtain the service identification information associated with the device identification information that is attached to the log information,
issues a request to obtain the user identification information associated with the device identification information,
issues a request to obtain the management identification information associated with the device identification information,
obtains, in response to the request to obtain the management identification information, the management identification information associated with the device identification information based on the mapping information,
obtains, in response to the request to obtain the user identification information, the user identification information associated with the management identification information obtained, based on the user information,
obtains, in response to the request to obtain the service identification information, the service identification information associated with the user identification information obtained, based on the service management information, and
stores the history information in which the log information is associated with the service identification information obtained.

8. The device management apparatus according to claim 6, wherein
the processing circuitry
stores, for each group of users, counter information indicating usage frequency of devices and usage frequency of applications that use devices, and
sends, in response to a request to obtain the counter information for a group, the counter information for the group to a device as a requestor.

9. The device management apparatus according to claim 1, wherein
the processing circuitry
collects state information that indicates device state from the device, and
stores the state information and the device identification information in association with each other.

10. The device management apparatus according to claim 1, wherein the processing circuitry receives various requests that are issued with respect to the device management apparatus.

11. The device management apparatus according to claim 10, wherein the processing circuitry has a WebAPI to receive the various requests via a network.

12. A device management system comprising:
the device management apparatus according to claim 1; and
one or more devices connected to the device management apparatus via a network.

13. A device management method comprising:
issuing management identification information for managing a device;
generating mapping information in which the management identification information is associated with device identification information for identifying the individual device; and
generating availability management information in which the device identification information is associated with availability indicating whether the device is available or unavailable, wherein
generating the mapping information includes generating the mapping information in which the management identification information associated with the device identification information of a first device is associated with the device identification information of a second device to be identified as the first device when generating, in response to a replacement request to replace the first device with the second device, the availability management information indicating that the first device is unavailable and the availability management information indicating that the second device is available.

14. A non-transitory recording medium with an executable program stored thereon, wherein the program instructs a computer to perform:
issuing management identification information for managing a device;
generating mapping information in which the management identification information is associated with device identification information for identifying the individual device; and
generating availability management information in which the device identification information is associated with availability indicating whether the device is available or unavailable, wherein
generating the mapping information includes generating the mapping information in which the management identification information associated with the device identification information of a first device is associated with the device identification information of a second device to be identified as the first device when generating, in response to a replacement request to replace the first device with the second device, the availability management information indicating that the first device is unavailable and the availability management information indicating that the second device is available.
